(19) United States
(12) Patent Application Publication
(10) Pub. No.: US 2007/0165197 A1
(43) Pub. Date: Jul. 19, 2007

(54) PIXEL POSITION ACQUIRING METHOD, IMAGE PROCESSING APPARATUS, PROGRAM FOR EXECUTING PIXEL POSITION ACQUIRING METHOD ON COMPUTER, AND COMPUTER-READABLE RECORDING MEDIUM HAVING RECORDED THEREON PROGRAM

(75) Inventor: Yoshihito YAMADA, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/623,995

(22) Filed: Jan. 17, 2007

(30) Foreign Application Priority Data
Jan. 18, 2006 (JP) 2006-009581
Jan. 18, 2006 (JP) 2006-009582

(51) Int. Cl. G03B 21/00

(52) U.S. Cl. 353/121

(57) ABSTRACT

A pixel position acquiring method includes displaying a first line image having a plurality of straight lines extending along a vertical direction of the image generating device and a second line image having a plurality of straight lines extending along a horizontal direction of the image generating device, capturing a display image based on the first and second line image and acquiring first or second image-capturing data, cutting a plurality of image-capturing lines mapped on the first and second image-capturing data per a region including each image-capturing line, setting an approximate function expressing each image-capturing line in the first and second image-capturing data on the basis of the region of each cut image-capturing line, and calculating, on the basis of the approximate functions, an association between the pixel position of the image generating device and the position where the pixel position is mapped on the image-capturing data.

The entire disclosure of Japanese Patent Application Nos. 2006-9581, filed Jan. 18, 2006 and 2006-9582, filed Jan. 18, 2006 are expressly incorporated by reference herein.

### BACKGROUND

1. Technical Field

The present invention relates to a pixel position acquiring method, an image processing apparatus, a program for executing a pixel position acquiring method on a computer, and a computer-readable recording medium having recorded thereon a program.

2. Related Art

In a fixed pixel type display, such as a liquid crystal projector or the like, display quality of an image or video of the fixed pixel type display is markedly improved by performing a pixel characteristic value (luminance and chromaticity) correction processing on each pixel.

A correction processing method or a correction amount of such a pixel characteristic value correction processing is set on the basis of a display principle of a fixed pixel type display or light-emission characteristics or transmission characteristics of pixels due to a manufacturing process or condition. Accordingly, a technology that accurately acquires characteristic values of pixels (luminance or chromaticity as the output of light-emission characteristics and transmission characteristics of pixels) of the fixed pixel type display is important.

In general, in the fixed pixel type display, the pixel characteristic values are acquired by displaying an appropriate image or video, capturing a display screen by an image-capturing device, such as a CCD camera or the like, and analyzing image-capturing data.

In the method of acquiring the pixel characteristic values of the fixed pixel type display, the characteristic values of the respective pixels need to be accurately acquired.

There are various causes that have an effect on accuracy when the characteristic values of the respective pixels are acquired. Among these, it is especially important to accurately acquire a position where each pixel of the fixed pixel type display is mapped on the image-capturing data.

For this reason, there is suggested a method that captures, using an image-capturing device, a state where a plurality of markers having a specific distribution are displayed on a display screen, calculates a correspondence between a display screen associated with the markers and image-capturing data, and acquires a position where each pixel position of the display screen is mapped on the image-capturing data (for example, see JP-A-2001-356005).

Further, there is suggested a method that acquires the contour of an image displayed on an image display device as straight lines, calculates protective transform of a display image and image-capturing data from intersections of the straight lines of the contour (that is, four corners of the display image), and executes a geometric correction of the image-capturing data using the projective transform (see JP-A-2005-12233).

In the technologies disclosed in JP-A-2001-356005 and JP-A-2005-122323, the correspondence between each pixel position of the display image and the mapped position on the image-capturing data is merely calculated on the basis of the dotlike markers or the points at the four corners of the display image. In this case, however, it is difficult to draw the correspondence with high accuracy.

Further, in the technologies disclosed in JP-A-2001-356005 and JP-A-2005-122323, in order to obtain the relationship between the pixel position and the mapped position on the captured image with high accuracy, the number of sampling points for drawing the correspondence increases, and the projective transform needs to be performed for the individual sampling points. Accordingly, an arithmetic processing is complicated.

In addition, when the display image is captured by the image-capturing device, a white saturation region may occur in the image-capturing data due to saturation of the image-capturing device or the like. Then, if a processing is performed on the basis of such image-capturing data, a resultant image may be different from an original display image. Accordingly, it may be impossible to perform a stable processing.

### SUMMARY

An advantage of some aspects of the invention is that it provides a pixel position acquiring method that rapidly, accurately and stably acquires a position where each pixel of a display is mapped on a captured image, an image processing apparatus, a program for executing the pixel position acquiring method on a computer, and a computer-readable recording medium having recorded thereon the program.

### 1. A Case where a Straight Line is Used as a Test Pattern

According to a first aspect of the invention, there is provided a pixel position acquiring method that captures a display image displayed on a screen by an image-capturing device, and acquires, on image-capturing data, a correspondence between a pixel position of an image generating device to be projected on the screen and a position where the pixel position is mapped on the image-capturing data. The pixel position acquiring method includes causing a first line image having a plurality of straight lines extending along a vertical direction of the image generating device to be displayed on the screen, capturing a display image based on the first line image by the image-capturing device and acquiring first image-capturing data, causing a second line image having a plurality of straight lines extending along a horizontal direction of the image generating device to be displayed on the screen, capturing a display image based on the second line image by the image-capturing device and acquiring second image-capturing data, cutting a plurality of image-capturing lines mapped on the first image-capturing data per a region including each image-capturing line, setting an approximate function expressing each image-capturing line in the first image-capturing data on the basis of the region of each cut image-capturing line, cutting a plurality of image-capturing lines mapped on the second image-capturing data per a region including each image-capturing line, setting an approximate function expressing each image-capturing line in the second image-capturing data on the basis of the region of each cut image-capturing line, and finding, on the basis of the approximate functions set by the first image-capturing data and the second image-capturing data, an association between the pixel position of the image generating device and the position where the pixel position is mapped on the image-capturing data.

With this configuration, the first line image or the second line image serving as the test pattern has a plurality of straight lines extending in a vertical or horizontal direction, and the approximate functions expressing the image-capturing lines mapped on the image-capturing data are set by the straight lines. Then, the pixel position of the image generating device and the position where the pixel position is mapped on the image-capturing data are associated with each other on the basis of the approximate functions. Accordingly, the association can be performed in consideration of a distortion of the image-capturing data due to a position of the image-capturing device with respect to an image display device having the screen and the image generating device or an optical element, such as a lens and the like, constituting the image-capturing device through the approximate functions. Therefore, the correspondence between the pixel position of the image generating device to be projected on the screen and the position where the pixel position is mapped on the image-capturing data can be acquired with high accuracy.

The association between the pixel position of the image generating device to be projected on the screen and the position where the pixel position is mapped on the image-capturing data can be performed with high accuracy only by displaying the first line image and the second line image. Therefore, the correspondence can be acquired at high speed.

In the pixel position acquiring method according to the first aspect of the invention, the first line image and the second line image each may include at least four markers providing the correspondence with the individual image-capturing data. The cutting of the plurality of image-capturing lines mapped on the first or second image-capturing data as the region including each image-capturing line may include setting, on the basis of a marker correspondence of the first line image and the first image-capturing data, a transform expression of the first line image and the first image-capturing data, setting, on the basis of a marker correspondence of the second line image and the second image-capturing data, a transform expression of the second line image and the second image-capturing data, setting a region surrounding each straight line of the first or second time image, transforming the region surrounding each straight line of the first or second line image by the set transform expression, and cutting, on the basis of the transformed region, each image-capturing line of the first image-capturing data or the second image-capturing data.

Here, the setting of the transform expression of the first line image and the first image-capturing data or the second line image and the second image-capturing data can be simply performed, for example, using a protective transform expression. Specifically, if a vector providing a mapping position of the image-capturing data is (x, y)^{T} and a vector providing a pixel position of a display image is (X, Y)^{T}, the following transform expression (1) can be obtained.

$$( \begin{matrix}wx \\ wy \\ w\end{matrix} ) = [ \begin{matrix}{a}_{0} & {a}_{1} & {a}_{2} \\ {a}_{3} & {a}_{4} & {a}_{5} \\ {a}_{6} & {a}_{7} & 1\end{matrix} ] ( \begin{matrix}WX \\ WY \\ W\end{matrix} ) \qquad ( 1 )$$

With this configuration, according to the transform expression set by the markers, if the region for cutting each image-capturing line is set by the first line image or the second line image, the cut region on the first image-capturing data or the second image-capturing data is simply found by the transform expression. Accordingly, each image-capturing line mapped on the first image-capturing data or the second image-capturing data can be cut without per forming a complex arithmetic processing. In particular, the transform can be more simply performed with the projective transform matrix of the transform expression (1).

In the pixel position acquiring method according to the first aspect of the invention, in the setting of the approximate function expressing each image-capturing line, when an xy coordinate system with a vertical direction of the first image-capturing data or the second image-capturing data as a y axis and a horizontal direction thereof as an x axis is set, each image-capturing line mapped on the first image-capturing data may be set as an approximate function expressed by a polynomial expression of x in a variable y, and each image-capturing line mapped on the second image-capturing data may be set as an approximate function expressed by a polynomial expression of y in a variable x.

With this configuration, each image-capturing line mapped on the first image-capturing data or the second image-capturing data is set as the approximate function provided by the polynomial expression. Accordingly, even though each image-capturing line mapped on the image-capturing data is a curve, the correspondence between the first and second line images and the first and second image-capturing data can be obtained with high accuracy. Further, since the approximate function is set by the polynomial expression according to the image-capturing line, the correspondence can be found without needing a complex arithmetic processing for finding the approximate function.

In the pixel position acquiring method according to the first aspect of the invention, the finding of the association between the pixel position of the image generating device and the position where the pixel position is mapped on the image-capturing data may include associating each straight line on the first line image with each, image-capturing line on the first image-capturing data, and associating each straight line on the second line image with each image-capturing line on the second image-capturing data, finding, on the basis of the approximate function set according to each associated image-capturing line, intersections of the plurality of image-capturing lines on the first image-capturing data and the plurality of image-capturing lines on the second image-capturing data, and setting, on the basis of the found intersections, an interpolation function for providing an arbitrary point within a region surrounded by two adjacent image-capturing lines on the first image-capturing data and two adjacent image-capturing lines on the second image-capturing data.

With this configuration, the interpolation function can be set on the basis of the image-capturing line associated with each straight line on the line image by the approximate function with high accuracy. Accordingly, the correspondence between an arbitrary pixel position of the image generating device and a position where the pixel position is mapped on the image-capturing data can be found with high accuracy.

The pixel position acquiring method according to the first aspect of the invention may further include, after the finding of the association between the pixel position of the image generating device and the position where the pixel position is mapped on the image-capturing data, performing a quality evaluation on the basis of the previously calculated correspondence between the pixel position of the image generating device and the position where the pixel position is mapped on the image-capturing data, and the recalculated correspondence between the pixel position of the image generating device and the position where the pixel position is mapped on the image-capturing data. When the evaluation result is bad, the causing of the first line image to be displayed on the screen to the finding of the association between the pixel position of the image generating device and the position where the pixel position is mapped on the image-capturing data may be repeated again.

With this configuration, the quality evaluation is performed so as to evaluate the correspondence between the pixel position and the position where the pixel position is mapped on the image-capturing data. Accordingly, when the evaluation result is bad, the correspondence between the pixel position of the image generating device and the position where the pixel position is mapped on the image-capturing data is found again. Therefore, the correspondence can be found with higher accuracy.

In the pixel position acquiring method according to the first aspect of the invention, upon the repetition, at least one of the causing of the first line image to be displayed and the causing of the second line image to be displayed may cause an updated line image with an interval between the straight lines narrower than the previous time to be displayed.

With this configuration, the correspondence is found again using an updated line image with a narrower interval between the straight lines. Then, the region surrounded by two adjacent image-capturing lines mapped on the first image-capturing data and two adjacent image-capturing lines mapped on the second image-capturing data becomes smaller than the previous time. Accordingly, the correspondence between an arbitrary pixel position within the region and a position where the pixel position is mapped on the image-capturing data can be found with higher accuracy.

In the pixel position acquiring method according to the first aspect of the invention, upon the repetition, at least one of the causing of the first line image to be displayed and the causing of the second line image to be displayed may cause a line image in which straight lines are arranged at different positions from the previous time to be displayed.

With this configuration, the association can be updated in a state where the image-capturing lines mapped on the image-capturing data are arranged at different positions from the previous time. Accordingly, there can be a high possibility that the distortion of the image-capturing data not detected at the previous time is detected, and the correspondence between an arbitrary pixel position within the region and a position within the region where the pixel position is mapped on the image-capturing data can be found with high accuracy. Further, since the number of image-capturing lines in the line image is the same, an arithmetic processing is not complicated, and the association can be found with the same load as the previous time.

Other aspects of the invention can be specified as an image processing apparatus that includes units for executing the individual steps constituting the above-described pixel position acquiring method, a program that executes the above-described pixel position acquiring method on a computer, and a computer-readable recording medium having recorded thereon the program, in addition to the above-described pixel position acquiring method. According to these aspects, it is possible to obtain an image processing apparatus and a computer that can exhibit the same advantages and effects as the above-described advantages and effects.

### 2. A Case where a Gradation Line is Used as a Test Pattern

According to a second aspect of the invention, there is provided a pixel position acquiring method that captures a display image displayed on a screen by an image-capturing device, and acquires, on the basis of image-capturing data, a correspondence between a pixel position of an image generating device to be displayed on the screen and a position where the pixel position is mapped on the image-capturing data. The pixel position acquiring method includes causing an image having a gradation line subjected to a gradation along an extension direction to be displayed on the screen, capturing the display image displayed on the screen by the image-capturing device and acquiring the image-capturing data, and associating, on the basis of the gradation line displayed on the screen and a gradation image-capturing line mapped on the image-capturing data, the pixel position of the image generating device with the position where the pixel position is mapped on the image-capturing data.

Here, examples of the image having the gradation line include an image having a plurality of gradation lines extending in a vertical direction to be described below, an image having a plurality of gradation lines extending in a horizontal direction to be described below, and an image, disclosed in JP-A-2005-122323, when the contour of the display image is acquired as a gradation line.

With this configuration, since the image-capturing data has the gradation line, even though a white saturation region occurs in the image-capturing data due to the saturation of the image-capturing device, there is no case where it is erroneously recognized as a line image for obtaining the correspondence with the display image. Therefore, the correspondence between the pixel position of the display image and the position mapped on the image-capturing data can be accurately and stably obtained.

In the pixel position acquiring method according to the second aspect of the invention, the causing the image having the gradation line to be displayed on the screen may include causing a first line image having a plurality of gradation lines extending along a vertical direction of the image generating device to be displayed on the screen, and causing a second line image having a plurality of gradation lines extending along a horizontal direction of the image generating device to be displayed on the screen. The acquiring of the image-capturing data may include capturing a display image based on the first line image by the image-capturing device and acquiring first image-capturing data, and capturing a display image based on the second line image by the image-capturing device and acquiring second image-capturing data. The associating of the pixel position of the image generating device and the position where the pixel position is mapped on the image-capturing data may include cutting a plurality of gradation image-capturing lines mapped on the first image-capturing data per a region including each gradation image-capturing line, setting an approximate function expressing each gradation image-capturing line in the first image-capturing data on the basis of the region of each cut gradation image-capturing line, cutting a plurality of gradation image-capturing lines mapped on the second image-capturing data per a region including each gradation image-capturing line, setting an approximate function expressing each gradation image-capturing line in the second image-capturing data on the basis of the region of each cut gradation image-capturing line, and finding, on the basis of the approximate functions set by the first image-capturing data and the second image-capturing data, the association between the pixel position of the image generating device and the position where the pixel position is mapped on the image-capturing data.

With this configuration, the first line image or the second line image serving as the test pattern has a plurality of gradation lines extending in a vertical or horizontal direction, and the approximate functions expressing the gradation image-capturing lines mapped on the image-capturing data are set. Then, the pixel position of the image generating device and the position where the pixel position is mapped on the image-capturing data are associated with each other on the basis of the approximate functions. Accordingly, the association can be performed in consideration of a distortion of the image-capturing data due to a position of the image-capturing device with respect to an image display device having the screen and the image generating device or an optical element, such as a lens and the like, constituting the image-capturing device through the approximate functions. Therefore, the correspondence between the pixel position of the image generating device and the position where the pixel position is mapped on the image-capturing data can be acquired with high accuracy.

The association between the pixel position of the image generating device and the position where the pixel position is mapped on the image-capturing data can be performed with high accuracy only by displaying the first line image and the second line image. Therefore, the correspondence can be acquired at high speed.

In the pixel position acquiring method according to the second aspect of the invention, the first line image and the second line image each may include at least four markers providing the correspondence with the individual image-capturing data. The cutting of the plurality of gradation image-capturing lines mapped on the first or second image-capturing data as the region including each gradation image-capturing line may include setting, on the basis of a marker correspondence of the first line image and the first image-capturing data, a transform expression of the first line image and the first image-capturing data, setting, on the basis of a marker correspondence of the second line image and the second image-capturing data, a transform expression of the second line image and the second image-capturing data, setting a region surrounding each gradation line of the first or second line image, transforming the region surrounding each gradation line of the first or second line image by the set transform expression, and cutting, on the basis of the transformed region, each gradation image-capturing line of the first image-capturing data or the second image-capturing data.

Here, the setting of the transform expression of the first line image and the first image-capturing data or the second line image and the second image-capturing data can be simply performed, for example, using a protective transform expression. Specifically, if a vector providing a mapping position of the image-capturing data is (x, y)^{T} and a vector providing a pixel position of a display image is (X, Y)^{T}, the above-described transform expression (1) can be obtained.

With this configuration, according to the transform expression set by the markers, if the region for cutting each gradation image-capturing line is set by the first line image or the second line image, the cut region on the first image-capturing data or the second image-capturing data is simply found by the transform expression. Accordingly, each gradation image-capturing line mapped on the first image-capturing data or the second image-capturing data can be cur without reforming a complex arithmetic processing. In particular, the transform can be more simply performed with the projective transform matrix of the above-described transform expression (1).

In the pixel position acquiring method according to the second aspect of the invention, in the setting of the approximate function expressing each gradation image-capturing line, when an xy coordinate system with a vertical direction of the first image-capturing data or the second image-capturing data as a y axis and a horizontal direction thereof as an x axis is set, each gradation image-capturing line mapped on the first image-capturing data may be set as an approximate function expressed by a polynomial expression of x in a variable y, and each gradation image-capturing line mapped on the second image-capturing data may be set as an approximate function expressed by a polynomial expression of y in a variable x.

With this configuration, each gradation image-capturing line mapped on the first image-capturing data or the second image-capturing data is set as the approximate function provided by the polynomial expression. Accordingly, even though each gradation image-capturing line mapped on the image-capturing data is a curve, the correspondence between the first and second line images and the first and second image-capturing data can be obtained with high accuracy. Further, since the approximate function is set by the polynomial expression according to the gradation image-capturing line, the correspondence can be found without needing a complex arithmetic processing for finding the approximate function.

In the pixel position acquiring method according to the second aspect of the invention, each gradation image-capturing line mapped on the first image-capturing data may be set as an approximate function expressed by a polynomial expression of x in a variable y using a weight coefficient according to the gradation image-capturing line. Each gradation image-capturing line mapped on the second image-capturing data may be set as an approximate function expressed by a polynomial expression of y in a variable x using a weight coefficient according to the gradation image-capturing line.

With this configuration, since the approximate function is set while weighting is performed, the approximate function can be found with higher accuracy.

In the pixel position acquiring method according to the second aspect of the invention, the finding of the association between the pixel position of the image generating device and the position where the pixel position is mapped on the image-capturing data may include associating each gradation line on the first line image with each gradation image-capturing line on the first image-capturing data, and associating each gradation line on the second line image with each gradation image-capturing line on the second image-capturing data, finding, on the basis of the approximate function set according to each associated gradation image-capturing line, intersections of the plurality of gradation image-capturing lines on the first image-capturing data and the plurality of gradation image-capturing lines on the second image-capturing data, and setting, on the basis of the found intersections, an interpolation function for providing an arbitrary point within a region surrounded by two adjacent gradation image-capturing lines on the first image-capturing data and two adjacent gradation image-capturing lines on the second image-capturing data.

With this configuration, the interpolation function can be set on the basis of the gradation image-capturing line associated with each gradation line on the line image by the approximate function with high accuracy. Accordingly, the correspondence between an arbitrary pixel position of the image generating device and a position where the pixel position is mapped on the image-capturing data can be found with high accuracy.

The pixel position acquiring method according to the second aspect of the invention may further include, after the finding of the association between the pixel position of the image generating device and the position where the pixel position is mapped on the image-capturing data, performing a quality evaluation on the basis of the previously calculated correspondence between the pixel position of the image generating device and the position where the pixel position is mapped on the image-capturing data, and the recalculated correspondence between the pixel position of the image generating device and the position where the pixel position is mapped on the image-capturing data. When the evaluation result is bad, the causing of the first line image to be displayed on the screen to the finding of the association between the pixel position of the image generating device and the position where the pixel position is mapped on the image-capturing data ray be repeated again.

With this configuration, the quality evaluation is performed so as to evaluate the correspondence between the pixel position and the position where the pixel position is mapped on the image-capturing data. Accordingly, when the evaluation result is bad, the correspondence between the pixel position and the position where the pixel position is mapped on the image-capturing data is found again. Therefore, the correspondence can be found with higher accuracy.

In the pixel position acquiring method according to the second aspect of the invention, upon the repetition, at least one of the causing of the first line image to be displayed and the causing of the second line image to be displayed may cause an updated line image with an interval between the gradation lines narrower than the previous time to be displayed.

With this configuration, the correspondence is found again using an updated line image with a narrower interval between the gradation lines. Then, the region surrounded by two adjacent gradation image-capturing lines mapped on the first image-capturing data and two adjacent gradation image-capturing lines mapped on the second image-capturing data becomes smaller than the previous time. Accordingly, the correspondence between an arbitrary pixel position within the region and a position where the pixel position is mapped on the image-capturing data can be found with higher accuracy.

In the pixel position acquiring method according to the second aspect of the invention, upon the repetition, at least one of the causing of the first line image to be displayed and the causing of the second line image to be displayed may cause a line image in which gradation lines are arranged at different positions from the previous time to be displayed.

With this configuration, the association can be updated in a state where the gradation image-capturing lines mapped on the image-capturing data are arranged at different positions from the previous time. Accordingly, there can be a high possibility that the distortion of the image-capturing data not detected at the previous time is detected, and the correspondence between an arbitrary pixel position within the region and a position within the region where the pixel position is mapped on the image-capturing data can be found with high accuracy. Further, since the number of gradation image-capturing lines in the line image is the same, an arithmetic processing is not complicated, and the association can be found with the same load as the previous time.

Other aspects of the invention can be specified as an image processing apparatus that includes units for executing the individual steps constituting the above-described pixel position acquiring method, a program that executes the above-described pixel position acquiring method on a computer, and a computer-readable recording medium having recorded thereon the program, in addition to the above-described pixel position acquiring method. According to these aspects, it is possible to obtain an image processing apparatus and a computer that can exhibit the same advantages and effects as the above-described advantages and effects.

### BRIEF DESCRIPTION OF THE DRAWINGS

The invention will be described with reference to the accompanying drawings, wherein like numbers reference like elements.

FIG. 1 is a schematic view showing the configuration of a pixel characteristic value acquiring system according to a first embodiment golf the invention.

FIG. 2 is a flowchart showing a processing in a display image introducing unit and a display image forming unit in the first embodiment.

FIG. 3 is a schematic view showing the configuration of vertical line image data.

FIG. 4 is a schematic view showing the configuration of horizontal line image data.

FIG. 5 is a flowchart showing a processing in a mapping region acquiring unit.

FIG. 6 is a schematic view illustrating a processing by a mapping region acquiring unit.

FIG. 7 is a schematic view illustrating a processing by a mapping region acquiring unit.

FIG. 8 is a flowchart showing a processing in an approximate function setting unit.

FIG. 9 is a schematic view illustrating a processing by an approximate function setting unit.

FIG. 10 is a flowchart showing a processing in a pixel mapping calculation unit.

FIG. 11 is a schematic view illustrating a processing by a pixel mapping calculation unit.

FIG. 12 is a flowchart showing the operations of the first embodiments.

FIG. 13 is a schematic view showing the configuration of a pixel characteristic value acquiring system according to a second embodiment of the invention.

FIG. 14 is a schematic view illustrating a processing by a pixel mapping calculation unit in the second embodiment.

FIG. 15 is a schematic view illustrating the reconstruction of image data in the second embodiment.

FIG. 16 is a flowchart showing the operations of the second embodiment.

FIG. 17 is a schematic view showing the configuration of a pixel characteristic value acquiring system according to a third embodiment of the invention.

FIG. 18 is a flowchart showing a processing in a display image introducing unit and a display image forming unit in the third embodiment.

FIG. 19 is a schematic view showing the configuration of vertical line image data.

FIG. 20 is a schematic view showing the configuration of horizontal line image data.

FIG. 21 is a flowchart showing a processing in a mapping region acquiring unit.

FIG. 22 is a schematic view illustrating a processing by a mapping region acquiring unit.

FIG. 23 is a schematic view illustrating a processing by a mapping region acquiring unit.

FIG. 24 is a flowchart showing a processing in an approximate function setting unit.

FIG. 25 is a schematic view illustrating a processing by an approximate function setting unit.

FIGS. 26A and 26B are graphs illustrating setting of a weight coefficient.

FIG. 27 is a flowchart showing a processing in a pixel mapping calculation unit.

FIG. 28 is a schematic view illustrating a processing by a pixel mapping calculation unit.

FIG. 29 is a flowchart showing the operations of the third embodiment.

FIG. 30 is a schematic view showing the configuration of a pixel characteristic value acquiring system according to a fourth embodiment of the invention.

FIG. 31 is a schematic view illustrating a processing by a pixel mapping calculation unit in the fourth embodiment.

FIG. 32 is a schematic view illustrating the reconstruction of image data in the fourth embodiment.

FIG. 33 is a flowchart showing the operations of the fourth embodiment.

### DESCRIPTION OF EXEMPLARY EMBODIMENTS

Hereinafter, embodiments of the invention will be described with reference to the drawings.

### First Embodiment

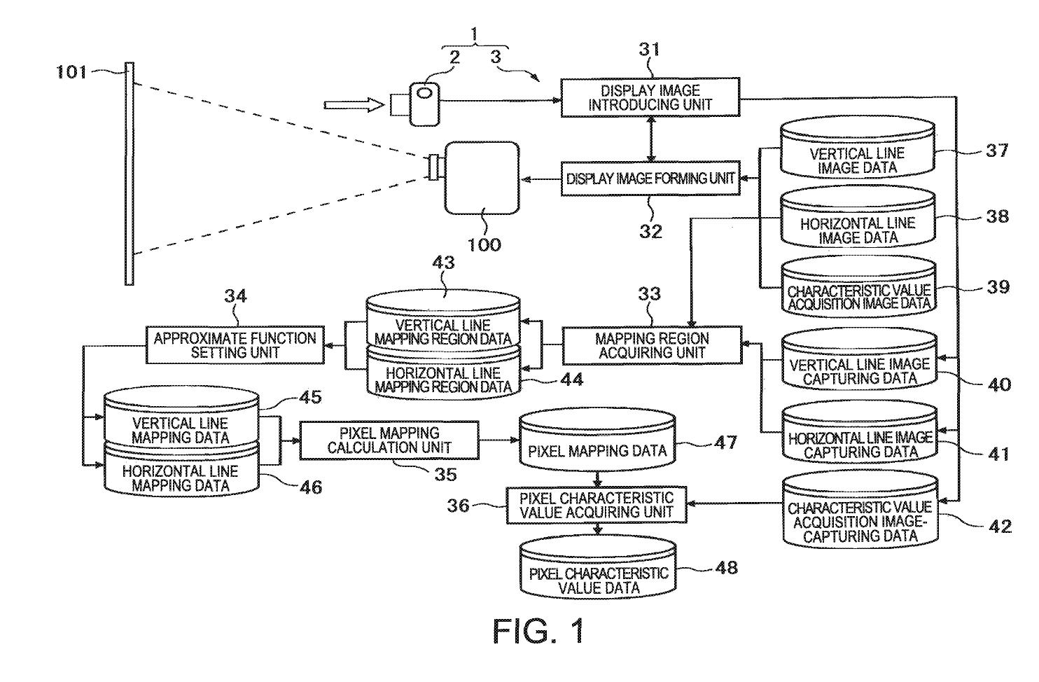

FIG. 1 shows a pixel characteristic value acquiring system 1 for executing a pixel position acquiring method according to a first embodiment of the invention. The pixel characteristic value acquiring system 1 acquires a pixel characteristic value, for example, luminance, chromaticity, or the like, for each pixel of a fixed pixel type display, such as a liquid crystal panel or the like, constituting a projector 100, and generates correction data for each pixel on the basis of the acquired pixel characteristic value. The pixel characteristic value acquiring system 1 includes an image-capturing device 2 and a computer 3.

As the image-capturing device 2, a CCD camera or a CMOS sensor is used. The image-capturing device 2 is disposed at a fixed position with respect to a screen 101 so as to capture a projection image on the basis of image data projected on the screen 101 and outputs acquired image-capturing data to the computer 3.

The computer 3 includes an arithmetic processing device and a storage device. The computer 3 processes the image-capturing data output from the image-capturing device 2, finds a correspondence between a pixel position on a display image displayed by the liquid crystal panel constituting the protector 100 and a position where the pixel position is mapped on the image-capturing data, and acquires the pixel characteristic value for each pixel. Specifically, the computer 3 includes a display image introducing unit 31, a display image forming unit 32, a mapping region acquiring unit 33, an approximate function setting unit 34, a pixel mapping calculation unit 35, and a pixel characteristic value acquiring unit 36. In the storage device, a vertical line image capturing data storage unit 40, a horizontal line image capturing data storage unit 41, a characteristic value acquisition image-capturing data storage unit 42, a vertical line mapping region data storage unit 43, a horizontal line mapping region data storage unit 44, a vertical line mapping data storage unit 45, a horizontal line mapping data storage unit 46, a pixel mapping data storage unit 47, and a pixel characteristic value data storage unit 48 that respectively stores data to be acquired or generated by a vertical line image data storage unit 37, a horizontal line image data storage unit 38, a characteristic value acquisition image data storage unit 39, and other functional units, all of which are prepared in advance, are secured. Hereinafter, a processing that is performed by each of the functional units will be described in detail.

### 1. Processing in Display Image Introducing Unit 31 and Display Image Forming Unit 32

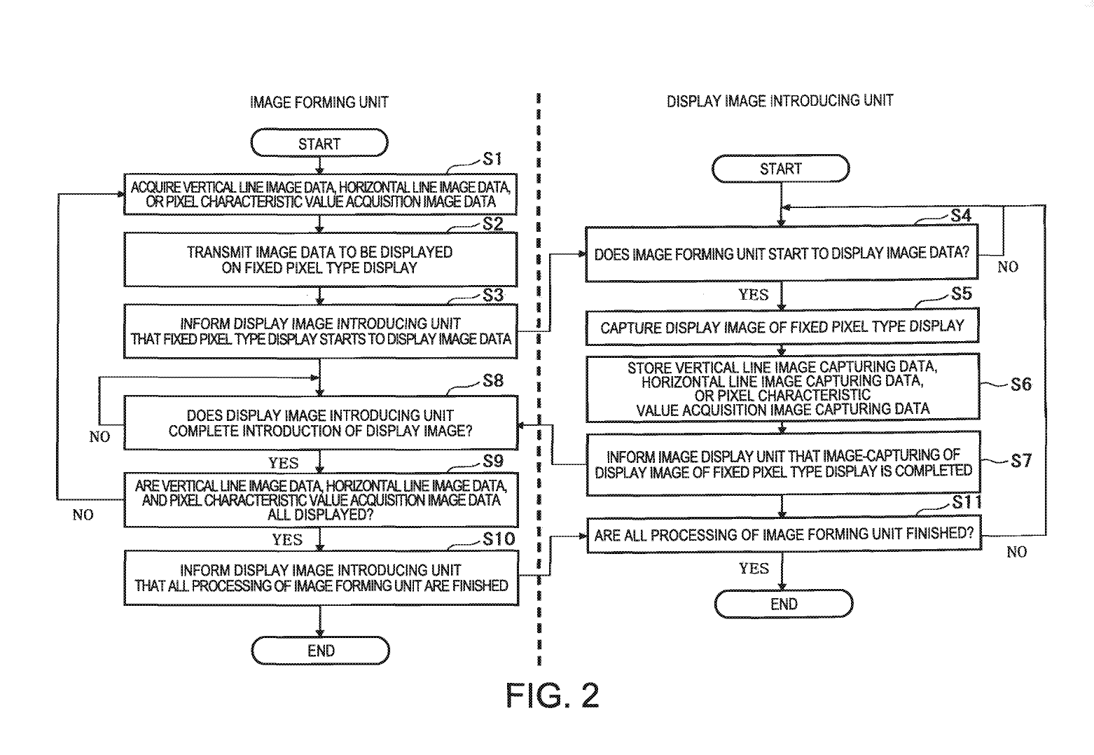

The display image introducing unit 31 and the display image forming unit 32 are a unit that outputs predetermined image data to the projector 100, from which a pixel characteristic value is to be acquired, causes a predetermined display image to be displayed on the screen 101 by the projector 100, captures the display image displayed on the screen 101 by the image-capturing device 2, and introduces the captured image as image-capturing data. Both units execute a series of steps shown in FIG. 2 together.

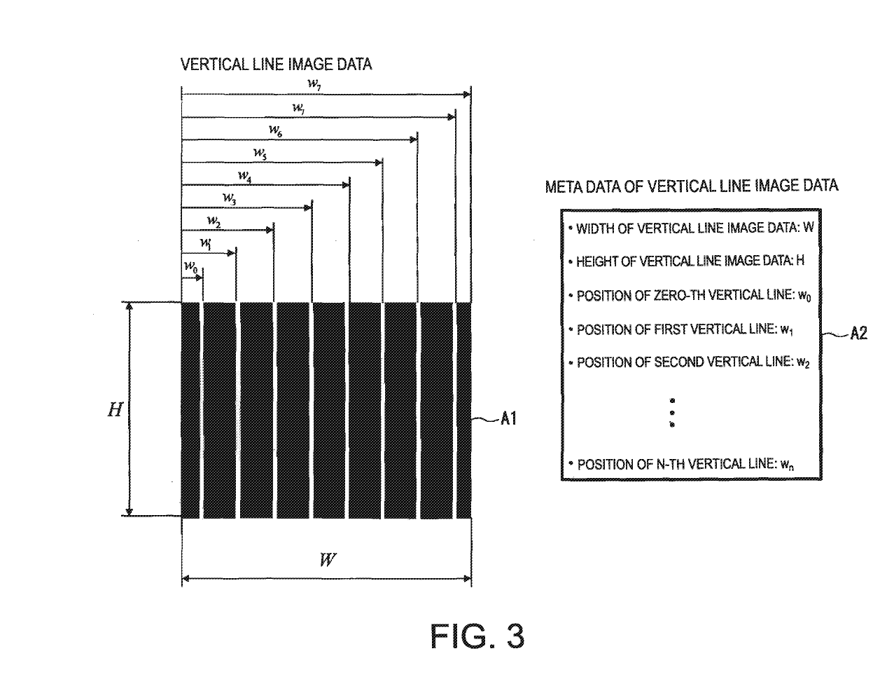

(1) First, the display image forming unit 32 reads out and acquires vertical line image data stored in the vertical line image data storage unit 37 (Step S1), and transmits the acquired data to the projector 100 (Step S2). Here, as shown in FIG. 3, the vertical line image data is an image A1 in which a plurality of straight lines extending in a vertical direction on a screen are arranged with predetermined intervals in a horizontal direction. Actually, the vertical line image data is recorded in the vertical line image data storage unit 37 as meta data A2 having a width W, a height H, a position w₀ of a zero-th vertical line, a position w, of a first vertical line, a position w₂ of a second vertical line, . . . in the image data.

(2) The display image forming unit 32 subsequently informs the display image introducing unit 31 that the projector 100 starts to display the vertical line image data (Step S3). When information purporting that image display starts is acquired from the display image forming unit 32 (Step S4), the display image introducing unit 31 captures the display image by the image-capturing device 2 (Step S5), introduces vertical line image capturing data into the computer 3, and stores the vertical line image capturing data in, the vertical line image capturing data storage unit 40 (Step S6).

(3) After the storage of the image-capturing data is finished, the display image introducing unit 31 subsequently informs the display image forming unit 32 of that purport (Step S7). When information purporting that image-capturing is finished is acquired (Step S8), the display image forming unit 32 starts to acquire next horizontal line image data (Step S9).

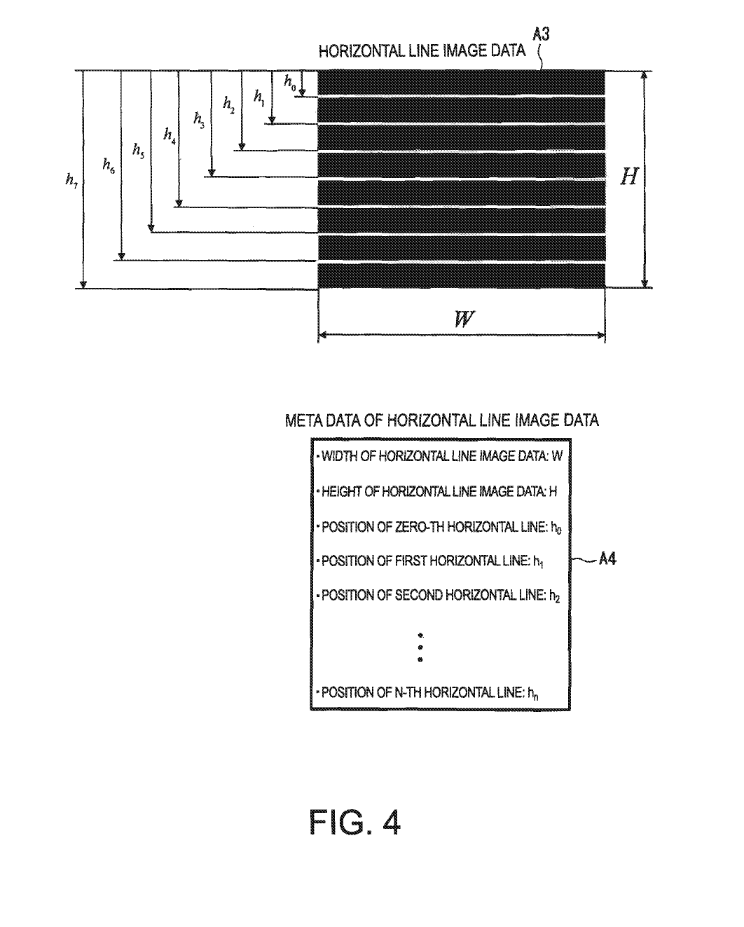

(4) Next, the display image forming unit 32 repeats the acquisition and display of horizontal line image data and the pixel characteristic value acquisition image data. Then, the display image introducing unit 31 sequentially stores image-capturing data of individual images in the horizontal line image capturing data storage unit 41 and the characteristic value acquisition image-capturing data storage unit 42. Moreover, as shown in FIG. 4, the horizontal line image data is an image A3 in which a plurality of straight lines extending in the horizontal direction are arranged with predetermined intervals in the vertical direction. The horizontal line image data storage unit 38 stores meta data A4 having a width W, a height H, a position h₀ of a zero-th horizontal line, a position h₁ of a first horizontal line, a position h₂ of a second horizontal line, . . . in the image data. Further, though not shown, the pixel characteristic value acquisition image data has a luminance signal, a color signal, and the like for causing all pixels to display predetermined luminance, color, and the like. For example, the pixel characteristic value acquisition image data is stored in the characteristic value acquisition image data storage unit 39 as data for judging a variation in voltage transmission characteristic (VT-γ) of each pixel.

(5) The display image introducing unit 31 captures a display image displayed on the basis of the horizontal line image data by the image-capturing device 2, introduces the captured image as horizontal line image capturing data, and stores the horizontal line image capturing data in the horizontal line image capturing data storage unit 41. Further, the display image introducing unit 31 captures a display image displayed on the basis of the pixel characteristic value acquisition image data by the image-capturing device 2, introduces the captured image as characteristic value acquisition image-capturing data, and stores the characteristic value acquisition image-capturing data in the characteristic value acquisition image-capturing data storage unit 42.

(6) The display image forming unit 32 judges, on the basis of all image data described above, whether or not they are displayed on the projector 100 (Step S9). If the display of all images is finished, the display image forming unit 32 informs the display image introducing unit 31 of that purport (Step S10), thereby ending the processing.

(7) The display image introducing unit 31 judges whether or not information purporting that the image display is finished is acquired from the display image forming unit 32 (Step S11. If the information purporting that the image display is finished is acquired, the display image introducing unit 31 ends the processing.

### 2. Processing in Mapping Region Acquiring Unit 33

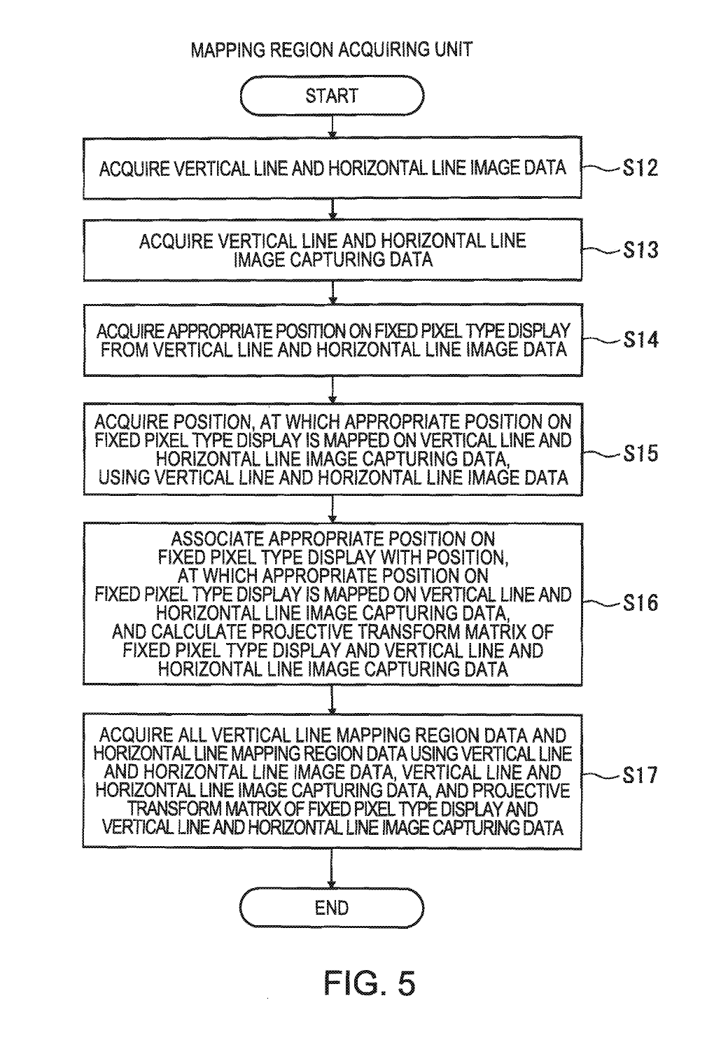

The mapping region acquiring unit 33 is a unit that finds a rough correspondence between the vertical line image data A1 and the horizontal line image data A3 and between the vertical line image capturing data and the horizontal line image capturing data obtained by capturing display images using the image-capturing device 2, and, on the basis of the correspondence, cuts each image-capturing line on the vertical line image capturing data and the horizontal line image capturing data. Specifically, the mapping region acquiring unit 33 performs a processing shown in FIG. 5.

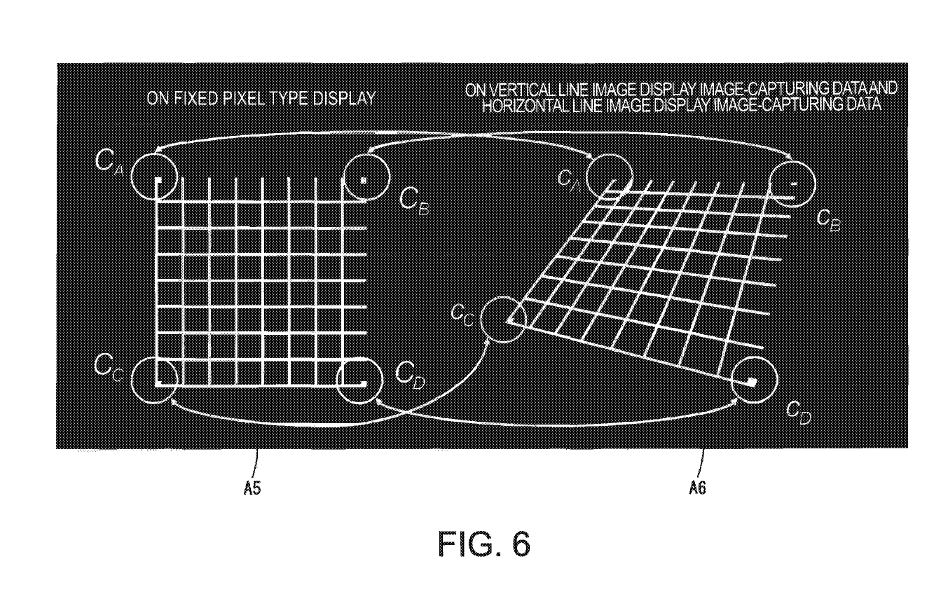

(1) First, the mapping region acquiring unit 33 acquires the vertical line image data A1 stored in the vertical line image data storage unit 37 and the horizontal line image data A3 stored in the horizontal line image data storage unit 38 (Step S12). If the acquired vertical line image data and horizontal line image data are superimposed, as shown in FIG. 6, a lattice-shaped image A5 is obtained.

(2) Next, the mapping region acquiring unit 33 acquires the vertical line image capturing data stored in the vertical line image capturing data storage unit 40 and the horizontal line image capturing data stored in the horizontal line image capturing data storage unit 41 (Step S13). If the acquired vertical line image capturing data and horizontal line image capturing data are superimposed, as shown in FIG. 6, the lattice-shaped image A5 is deformed according to an image-capturing position of the image-capturing device 2 with respect to the screen 101, and then an image A6 is acquired.

(3) The mapping region acquiring unit 33 acquires positions of markers C_{A}, C_{B}, C_{C}, and C_{D} at corners of the image A5 as the prescribed vertical line image data and horizontal line image data (Step S14).

(4) Next, the mapping region acquiring unit 33 acquires mapping positions c_{A}, c_{B}, c_{C}, and c_{D} where the markers c_{A}, c_{B}, c_{C}, and c_{D} of the image A5 are mapped on the image A6 as the image-capturing data (Step S15).

(5) The mapping region acquiring unit 33 calculates a projective transform matrix on the basis of the correspondence between the markers C_{A}, C_{B}, C_{C}, and C_{D} and the mapping positions c_{A}, c_{B}, c_{C}, and c_{D} (Step S16). Specifically, if an arbitrary constant w is set with respect to a vector (x, y)^{T} by incrementing a coordinate axis and a vector (wx, wy, w)^{T} is established, a projective transform can be expressed by a transform expression, for example, the following expression (2).

$$( \begin{matrix}wx \\ wy \\ w\end{matrix} ) = [ \begin{matrix}{a}_{0} & {a}_{1} & {a}_{2} \\ {a}_{3} & {a}_{4} & {a}_{5} \\ {a}_{6} & {a}_{7} & 1\end{matrix} ] ( \begin{matrix}WX \\ WY \\ W\end{matrix} ) \qquad ( 2 )$$

If the transform expression (2) is arranged, a mapping position coordinate (x, y) of each of the mapping positions c_{A}, c_{B}, c_{C}, and c_{D} is provided by the following expressions (3) and (4) using a marker coordinate (X, Y).

$$\begin{matrix}x = \frac{wx}{w} = \frac{{a}_{0} WX + {a}_{1} WY + {a}_{2} W}{{a}_{6} WX + {a}_{7} WY + W} = \frac{{a}_{0} X + {a}_{1} Y + {a}_{2}}{{a}_{6} X + {a}_{7} Y + 1} & ( 3 ) \\ y = \frac{wy}{w} = \frac{{a}_{3} WX + {a}_{4} WY + {a}_{5} W}{{a}_{6} WX + {a}_{7} WY + W} = \frac{{a}_{3} X + {a}_{4} Y + {a}_{5}}{{a}_{6} X + {a}_{7} Y + 1} & ( 4 )\end{matrix}$$

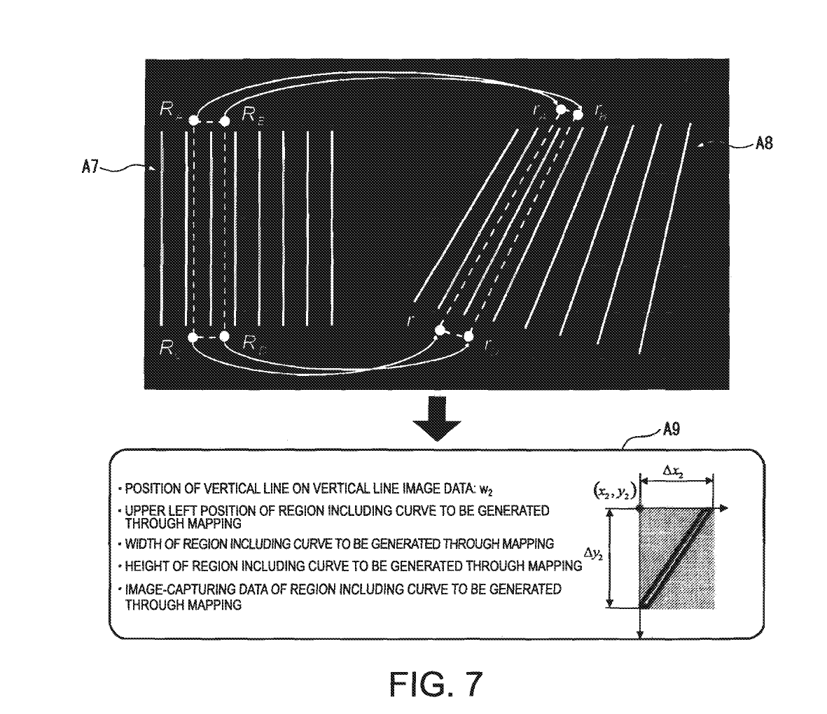

(6) After the correspondence between the mapping position coordinate (x, y) and the marker coordinate (X, Y) is found, the mapping region acquiring unit 33 performs a processing of cutting a straight line on an image A7 representing vertical line image data shown in FIG. 7 from the vertical line image data by surrounding the straight line with points R_{A}, R_{B}, R_{C}, and R_{D}. Then, the mapping region acquiring unit 33 finds coordinates (x, y) of points r_{A}, r_{B}, r_{C}, and r_{D} mapped on an image A8 as vertical line image capturing data from the coordinates (X, Y) of the points R_{A}, R_{B}, R_{C}, and R_{D} through the expressions (3) and (4). Subsequently, the mapping region acquiring unit 33 cuts an image-capturing line on the image A8 on the basis of the individual found coordinates and acquires vertical line mapping region data (Step S17). In case of a third vertical line having a distance w₂ from a left end of the vertical line image data of FIG. 7, as shown in an image A9, the acquired vertical line mapping region data is image-capturing data according to a position W₂ on the vertical line image data, an upper left position (x₂, y₂) of a region including an image-capturing line to be generated through mapping to the vertical line image capturing data, a width Δx₂ of the region including the image-capturing line, a height Δy₂ of the region including the image-capturing line, and a region where the image-capturing line is surrounded with the points r_{A}, r_{B}, r_{C}, and r_{D}. The acquired vertical line mapping region data is stored in the vertical line mapping region data storage unit 43 for each image-capturing line. Moreover, horizontal line mapping region is found in the same manner as the vertical line and is stored in the horizontal line mapping region data storage unit 44 as the same data structure.

### 3. Processing in Approximate Function Setting Unit 34

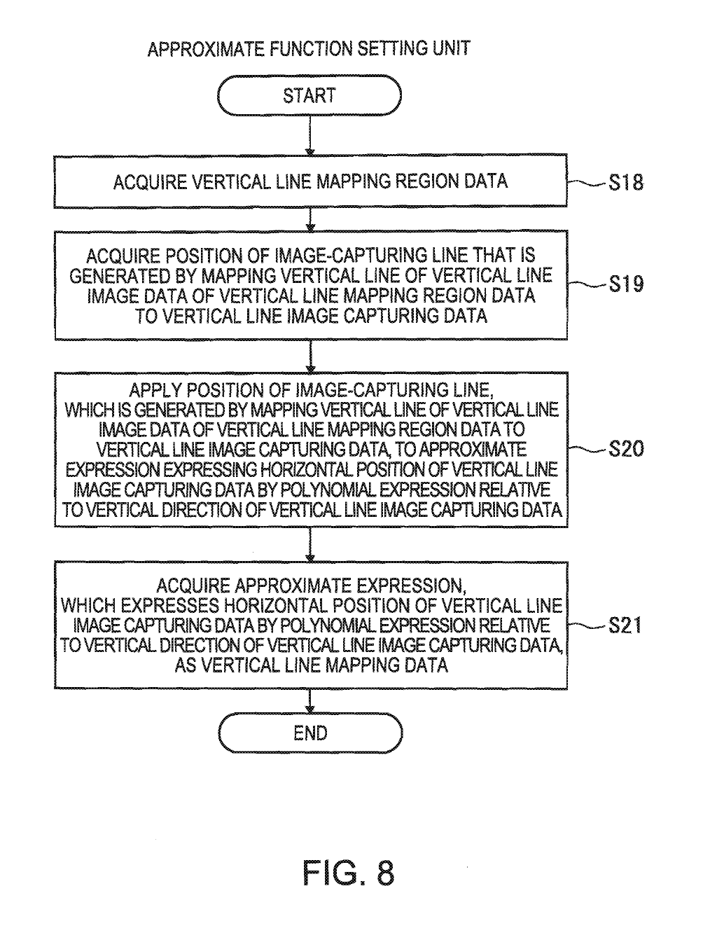

The approximate function setting unit 34 sets an approximate function representing each image-capturing line on the basis of the mapping region data stored in the vertical line mapping region data storage unit 43 and the horizontal line mapping region data storage unit 44. For example, in case of the vertical line mapping region data, a processing shown in a flowchart of FIG. 8 is performed so as to set the approximate function.

(1) First, the approximate function setting unit 34 acquires vertical line mapping region data from the vertical line mapping region data storage unit 43 (Step S18).

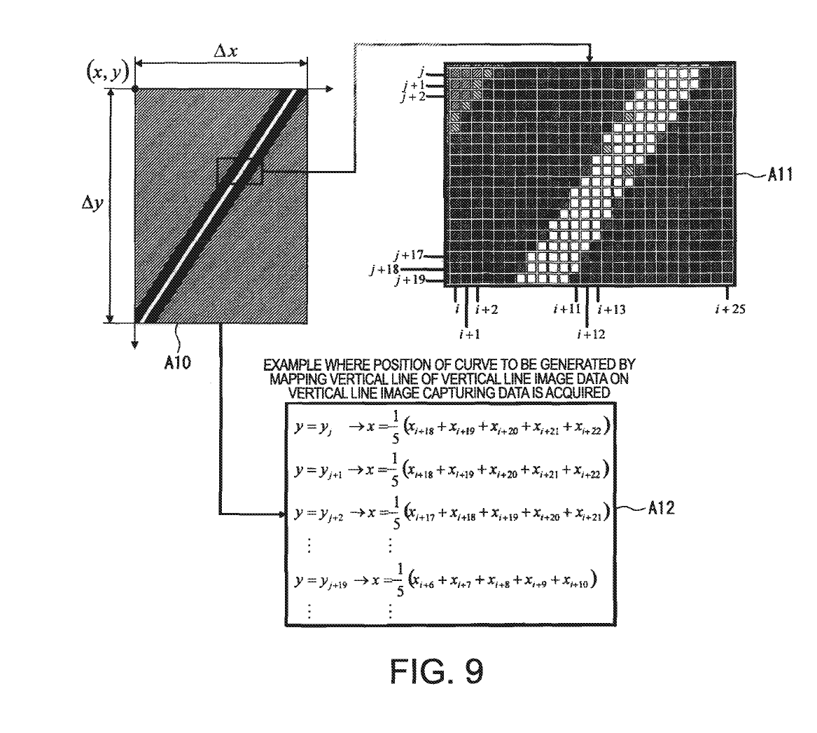

(2) Next, the approximate function setting unit 34 acquires the position of an image-capturing line to be generated through mapping of a vertical line of vertical line image data to vertical line image capturing data (Step S19). As shown in FIG. 9, the acquisition of the position of the image-capturing line is performed by finding a spread range of a horizontal position x of the vertical line image capturing data at a vertical position y relative to vertical line mapping region data, such as an image A10, and finding a representative value of the horizontal position x at the vertical position y on the basis of the spread range. In this embodiment, as shown in an image A1, of FIG. 9, since a bright spot indicating an image-capturing line for a vertical position yⱼ₊₁₇ has a spread of xᵢ₊₇ to xᵢ₊₁₁ in the horizontal direction, a horizontal position x with respect to the vertical position yⱼ₊₁₇ is an average of the five points. Then, the horizontal position x is calculated for all vertical positions y in the vertical line image capturing data, and a group of data (x, y) providing an image-capturing line, such as A12 of FIG. 9, is acquired.

(3) Next, the approximate function setting unit 34 applies the position of the image-capturing line, which is generated through mapping of the vertical line of the vertical line image data in the vertical line mapping region data to the vertical line image capturing data, to the approximate function that represents a horizontal position X of the vertical line image capturing data by a polynomial expression about a vertical direction Y of the vertical line image capturing data (Step S20). Specifically, as regards the approximate function, when the horizontal position X is expressed by a polynomial expression of the vertical position Y, and when an order of the polynomial expression is M, the number of positional coordinates on the image-capturing line is N, a horizontal component of image-capturing data of a positional coordinate on the image-capturing line is μₓ, a vertical component of image-capturing data of the positional coordinate on the image-capturing line is μ_{y}, an average of the horizontal components of the image-capturing data of the positional coordinate on the image-capturing line is σₓ, an average of the vertical components of the image-capturing data on the image-capturing line is σ_{y}, a standard deviation of the horizontal components of the image-capturing data of the positional coordinate on the image-capturing line is σₓ, and a standard deviation of the vertical components of the image-capturing data on the image-capturing line is σ_{y}, the relationship between the horizontal position X and the vertical position Y is provided by the following expression (5).

$$X = {\sum }_{j = 0}^{M} {A}_{j} {Y}^{j} \qquad ( 5 )$$

Here, X, Y, μₓ, and μ_{y} are defined as follows, respectively.

$$X = \frac{x - {μ}_{x}}{{σ}_{x}}$$

$$Y = \frac{y - {μ}_{y}}{{σ}_{y}}$$

$${μ}_{x} = \frac{1}{N} {\sum }_{n = 0}^{N} {x}_{n} , {σ}_{x}^{2} = \frac{1}{N} {\sum }_{n = 0}^{N} {( {x}_{n} - {μ}_{x} )}^{2}$$

$${μ}_{y} = \frac{1}{N} {\sum }_{n = 0}^{N} {y}_{n} , {σ}_{y}^{2} = \frac{1}{N} {\sum }_{n = 0}^{N} {( {y}_{n} - {μ}_{y} )}^{2}$$

(4) Finally, the approximate function setting unit 34 acquires the obtained approximate expression (5) as vertical line mapping data, together with the vertical line position w on the vertical line image data and stores the acquired vertical line mapping data in the vertical line mapping data storage unit 45 (Step S21).

In case of the horizontal line mapping region data, horizontal line mapping data is acquired in the same manner as the vertical line mapping region data. In this case, however, when a group of data corresponding to the image A10 is acquired, a spread range of the vertical position y with respect to each horizontal position x is found and an average of the vertical positions y is found. Then, the vertical position Y is expressed by a polynomial expression of the horizontal position X. Specifically, the following expression (6) is provided, and the obtained approximate expression (6) is stored in the horizontal line mapping data storage unit 46, together with a horizontal line position h of the horizontal line image data.

$$Y = {\sum }_{i = 0}^{M} {A}_{i} {Y}^{i} \qquad ( 6 )$$

Here, X, Y, μₓ, and μ_{y} are defined as follows, respectively.

$$X = \frac{x - {μ}_{x}}{{σ}_{x}} , Y = \frac{y - {μ}_{y}}{{σ}_{y}}$$

$${μ}_{x} = \frac{1}{N} {\sum }_{n = 0}^{N} {x}_{n} , {σ}_{x}^{2} = \frac{1}{N} {\sum }_{n = 0}^{N} {( {x}_{n} - {μ}_{x} )}^{2}$$

$${μ}_{y} = \frac{1}{N} {\sum }_{n = 0}^{N} {y}_{n} , {σ}_{y}^{2} = \frac{1}{N} {\sum }_{n = 0}^{N} {( {y}_{n} - {μ}_{y} )}^{2}$$

### 4. Processing in Pixel Mapping Calculation Unit 35

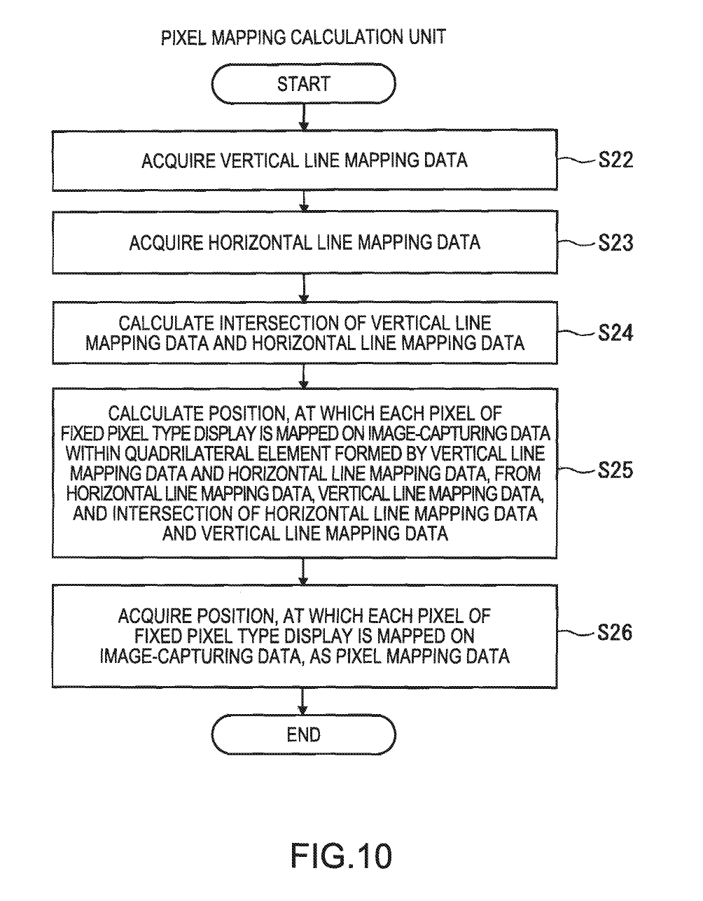

The pixel mapping calculation unit 35 calculates, on the basis of the vertical line mapping data and the horizontal line mapping data obtained by the approximate function setting unit 34, to which of the image-capturing data a pixel position of a display image displayed by a liquid crystal panel constituting the projector 100 or the like is mapped. Specifically, the pixel mapping calculation unit 35 performs a processing shown in a flowchart of FIG. 10.

(1) First, the pixel mapping calculation unit 35 acquires the vertical line mapping data stored in the vertical line mapping data storage unit 45 (Step S22), and subsequently acquires the horizontal line mapping data stored in the horizontal line mapping data storage unit 46 (Step S23).

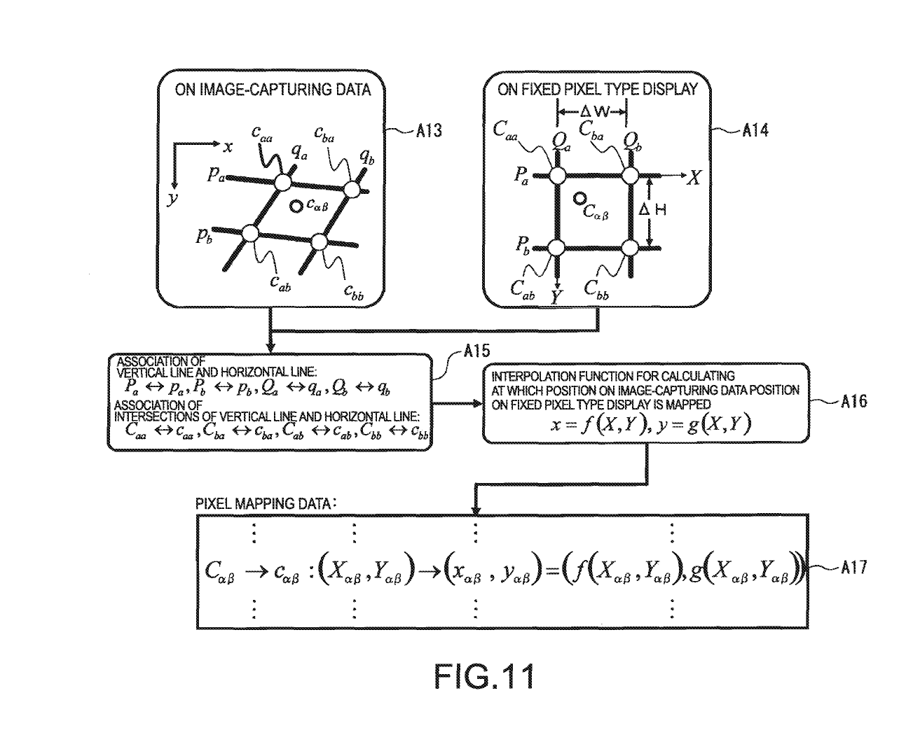

(2) Next, the pixel mapping calculation unit 35 calculates an intersection of the vertical line mapping data and the horizontal line mapping data (Step S24), and calculates, from the horizontal line mapping data, the vertical line mapping data, and the intersection thereof, a position where each pixel position of the display image displayed by the liquid crystal panel of the fixed pixel type display or the like is mapped on the image-capturing data within a quadrilateral region defined by the vertical line mapping data and the horizontal line mapping data (Step S25). Specifically, in this embodiment, as shown in FIG. 11, intersections cₐₐ, c_{ab}, c_{ba}, and c_{bb} (image A13) of image-capturing lines pₐ and p_{b} on the horizontal line image capturing data and image-capturing lines qₐ and q_{b} on the vertical line image capturing data are respectively associated with intersections Cₐₐ, C_{ab}, C_{ba}, and C_{bb} (image A14) of horizontal lines Pₐ and P_{b} on the horizontal line image data displayed by the liquid crystal panel of the fixed pixel type display or the like and vertical lines Qₐ and Q_{b} on the vertical line image data (A15). Then, the pixel mapping calculation unit 35 calculates by which interpolation function a position (x, y) of the image-capturing data is mapped to a pixel position (X, Y) of the display image (A16) from the correspondence of respective intersections.

(3) As regards the calculation of the interpolation function by the pixel mapping calculation unit 35, specifically, a coordinate (x, y) of an arbitrary point c_{αβ} within the quadrilateral region in the image A13 can be expressed by the following expressions (7) and (8) using a coordinate (xₐₐ, yₐₐ, of the intersection cₐₐ, a coordinate (x_{ab}, y_{ab}) of the intersection c_{ab}, a coordinate (x_{ba}, y_{ba}) of the intersection c_{ba}, and a coordinate (x_{bb}, y_{bb}) of the intersection c_{bb}.

x=Nₐₐxₐₐ+N_{ba}x_{ba}+N_{ab}x_{ab}+N_{bb}x_{bb} (7)

y=Nₐₐyₐₐ+N_{ba}y_{ba}+N_{ab}y_{ab}+N_{bb}y_{bb} (8)

Here, when a horizontal distance between the intersections Cₐₐ and C_{ba} in the quadrilateral region of the display image is ΔW, and a vertical distance between the intersections C_{ba} and C_{bb} is ΔH, coefficients Nₐₐ, N_{ba}, N_{ab}, and N_{bb} are provided by the following expressions (9) to (12), respectively. Accordingly, the coordinate (x, y) of the arbitrary point c_{αβ} within the quadrilateral region mapped on the image-capturing data shown in the image A13 can be expressed as a coordinate (X, Y) of a corresponding point C_{αβ} of the quadrilateral region on the display image shown in the image A14. Then, the interpolation function that provides the correspondence between the pixel position on the display image and the mapping position where the pixel position is mapped on the image-capturing data can be calculated.

$$\begin{matrix}{N}_{aa} = \frac{Δ W - X}{Δ W} \frac{Δ H - Y}{Δ H} & ( 9 ) \\ {N}_{ba} = \frac{X}{Δ W} \frac{Δ H - Y}{Δ H} & ( 10 ) \\ {N}_{ab} = \frac{Δ W - X}{Δ W} \frac{Y}{Δ H} & ( 11 ) \\ {N}_{bb} = \frac{X}{Δ W} \frac{Y}{Δ H} & ( 12 )\end{matrix}$$

(4) In such a manner, the pixel mapping calculation unit 35 calculates the interpolation function that provides the correspondence between all arbitrary mapping positions within the quadrilateral region mapped on the image-capturing data and all arbitrary pixel positions within the quadrilateral region on the display image, and stores the calculated interpolation function in the pixel mapping data storage unit 47 as pixel mapping data (Step S26).

### 5. Processing in Pixel Characteristic Value Acquiring Unit 36

The pixel characteristic value acquiring unit 36 acquires a characteristic value of each pixel on the display image on the basis of the characteristic value acquisition image-capturing data stored in the characteristic value acquisition image-capturing data storage unit 42 and the pixel mapping data stored in the pixel mapping data storage unit 47. The pixel characteristic value acquiring unit 36 acquires the pixel characteristic value as follows.

(1) First, the pixel characteristic value acquiring unit 36 acquires the characteristic value acquisition image-capturing data from the characteristic value acquisition image-capturing data storage unit 42 and acquires the characteristic value on the image-capturing data. As the characteristic value, numeric data, such as a luminance value, color irregularity, and the like, is provided.

(2) Next, the pixel characteristic value acquiring unit 36 acquires the pixel mapping data from the pixel mapping data storage unit 47, and acquires, on the basis of the correspondence between each pixel position on the display image and the mapping position where the pixel position is mapped on the image-capturing data, characteristic value data, such as the luminance value, color irregularity, and the like, of a position where the pixel position is mapped on the image-capturing data.

(3) Finally, the pixel characteristic value acquiring unit 36 stores the characteristic value data according to all pixel positions on the display image in the pixel characteristic value data storage unit 48 as pixel characteristic value data.

### 6. Operation of the Embodiment

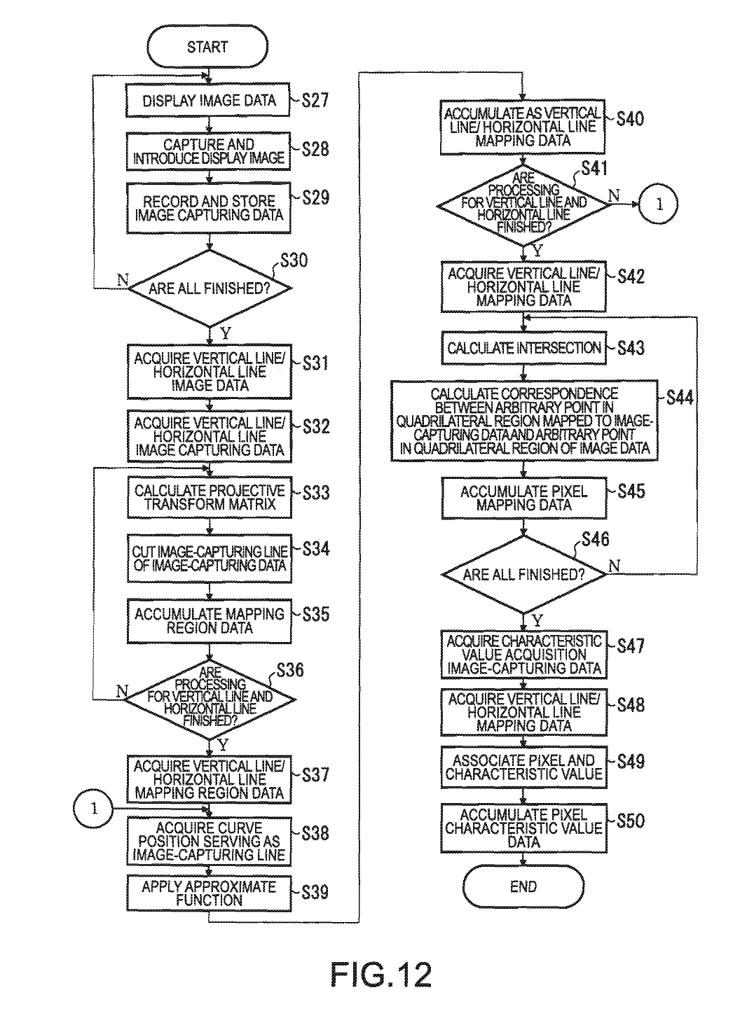

Next, an overall flow of the pixel characteristic value acquiring method to be executed by the above-described individual functional units will be described with reference to a flowchart shown in FIG. 12.

(1) The display image forming unit 32 causes images based on the vertical line image data, the horizontal line image data, and the characteristic value acquisition image data to be sequentially displayed on the projector 100 (Step S27). Then, the display image forming unit 32 captures the display image displayed on the screen 101 according to each image data by the image-capturing device 2 and the captured images are sequentially introduced as image-capturing data by the display image introducing unit 31 (Step S28). Subsequently, the image-capturing data is recorded and stored in the vertical line image capturing data storage unit 40, the horizontal line image capturing data storage unit 41, and the characteristic value acquisition image-capturing data storage unit 42 (Step S29).

(2) When it is judged that the introduction of all image-capturing data by the display image introducing unit 31 is finished (Step S30), the mapping region acquiring unit 33 acquires the vertical line image data and the horizontal line image data (Step S31), and acquires the vertical line image capturing data and the horizontal line image capturing data (Step S32).

(3) The mapping region acquiring unit 33 first grasps to which position on the vertical line image capturing data the marker position set on the vertical line image data is mapped and calculates the expressions (3) and (4) representing the correspondence between the marker position and the mapping position (Step S33). After the expressions (3) and (4) are calculated, the mapping region acquiring unit 33 sets a region surrounding each straight line to be set on the vertical line image data and cuts each image-capturing line from a region mapped on the image-capturing data transformed by the expressions (3) and (4) on the basis of the set region (Step S34). Then, the obtained vertical line mapping region data is stored in the vertical line mapping region data storage unit 43 (Step S35).

(4) Similarly, for the horizontal line image data and the horizontal line image capturing data, each image-capturing line on the image-capturing data is cut on the basis of the expressions (3) and (4) and is stored as the horizontal line mapping region data. This processing is repeated until the mapping region data is acquired for all image-capturing lines of the vertical and horizontal lines (Step S36).

(5) After the acquisition of the mapping region data by the mapping region acquiring unit 33 is finished, the approximate function setting unit 34 acquires the vertical line mapping region data and the horizontal line mapping region data (Step S37).

(6) The mapping region acquiring unit 33 acquires the position of an image-capturing line providing each image-capturing line stored as the vertical line mapping region data (Step S38), and subsequently applies an approximate unction of the polynomial expression to be provided by the expression (5) that approximates the image-capturing line (Step S39).

(7) The obtained approximate function is stored in the vertical line mapping data storage unit 45 as the vertical line mapping data (Step S40).

(8) The mapping region acquiring unit 33 sets an approximate function in the same manner using the expression (6) for applying an image-capturing line in the horizontal line mapping data on the basis of the horizontal line mapping region data. If the setting of the approximate function and the storage of the mapping data for all image-capturing lines on the mapping region data are finished (Step S41), the processing ends.

(9) Next, the pixel mapping calculation unit 35 acquires the vertical line mapping data and the horizontal line mapping data (Step S42), and calculates an intersection of a vertical line image-capturing line and a horizontal line image-capturing line on the basis of the approximate function providing each vertical line mapping data and the approximate function providing each horizontal line mapping data (Step S43).

(10) The pixel mapping calculation unit 35 calculates, on the basis of the expressions (7) and (8), an interpolation function providing the correspondence between an arbitrary point within a quadrilateral region to be generated by the vertical line mapping data and the horizontal line mapping data and a point within the quadrilateral region by the vertical line image data and the horizontal line image data corresponding to the arbitrary point (Step S44).

(11) The pixel mapping calculation unit 35 stores the calculated interpolation function as the pixel mapping data (Step S45). The processing is repeated until the interpolation functions are found for all regions within the vertical and horizontal lines (Step S46).

(12) After the calculation of the interpolation function by the pixel mapping calculation unit 35 is finished, the pixel characteristic value acquiring unit 36 acquires the characteristic value acquisition image-capturing data from the characteristic value acquisition image-capturing data storage unit 42 (Step S47) and acquires the pixel mapping data from the pixel mapping data storage unit 47 (Step S48). Then, each pixel on the display image is associated with the characteristic value (Step S49), and the association is stored in the pixel characteristic value data storage unit 48 as the pixel characteristic value data (Step S50).

According to this embodiment, the vertical line image data and the horizontal line image data are used as the pixel position acquisition image data. Accordingly, a complex distortion that occurs between the pixel position on the display image and the position where the pixel position is mapped on the image-capturing data due to the image-capturing device 2 can be grasped as the approximate function with high accuracy. Therefore, the correspondence between the pixel position of the display image and the position where the pixel position is mapped to the image-capturing data can be acquired with high accuracy.

Further, since the correspondence can be grasped with high accuracy by the above expressions (1) to (12), the correspondence can be simply found with high accuracy without performing a complex arithmetic processing.

### Second Embodiment

Next, a second embodiment of the invention will be described. Moreover, in the following description, the same parts as those described above are represented by the same reference numerals, and the descriptions thereof will be omitted.

In the first embodiment described above, the pixel mapping data is calculated by the pixel mapping calculation unit 35, and then the pixel characteristic value is immediately acquired by the pixel characteristic value acquiring unit 36.

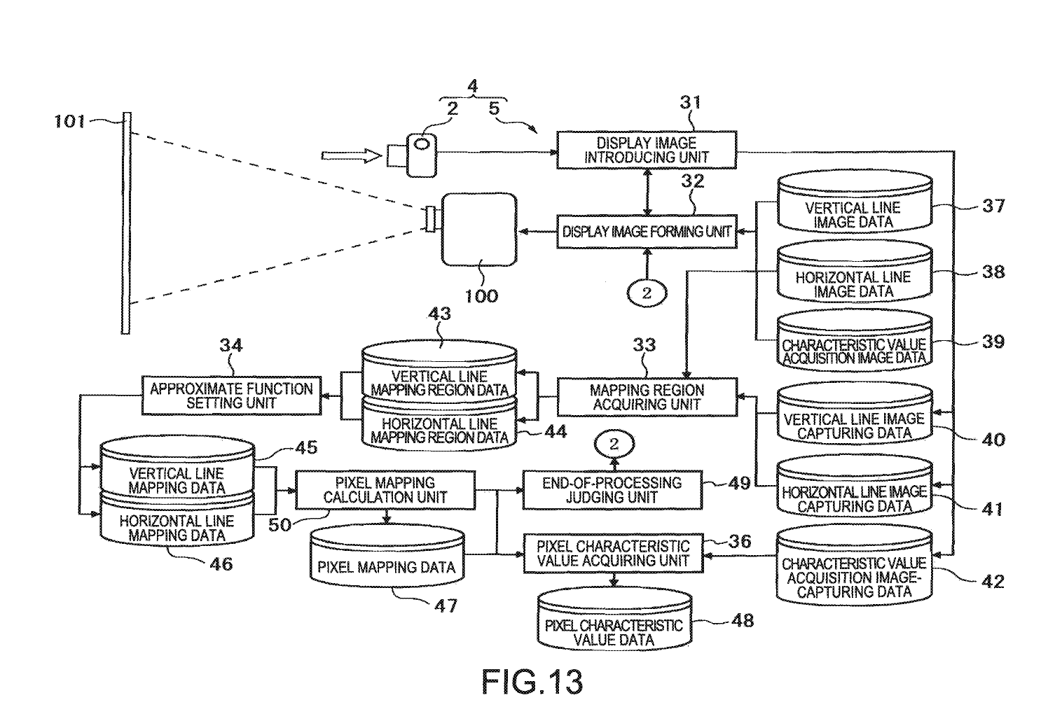

In contrast, in a pixel characteristic value acquiring system 4 according to the second embodiment, as shown in FIG. 13, an end-of-processing judging unit 49 is provided in a computer 5. Then, when it is judged that the pixel mapping data is not appropriate, display and introduction of the image data are performed again, and the pixel mapping data is calculated by a pixel mapping calculation unit 50. This processing is repeated until appropriate pixel mapping data obtained. These are different from the first embodiment.

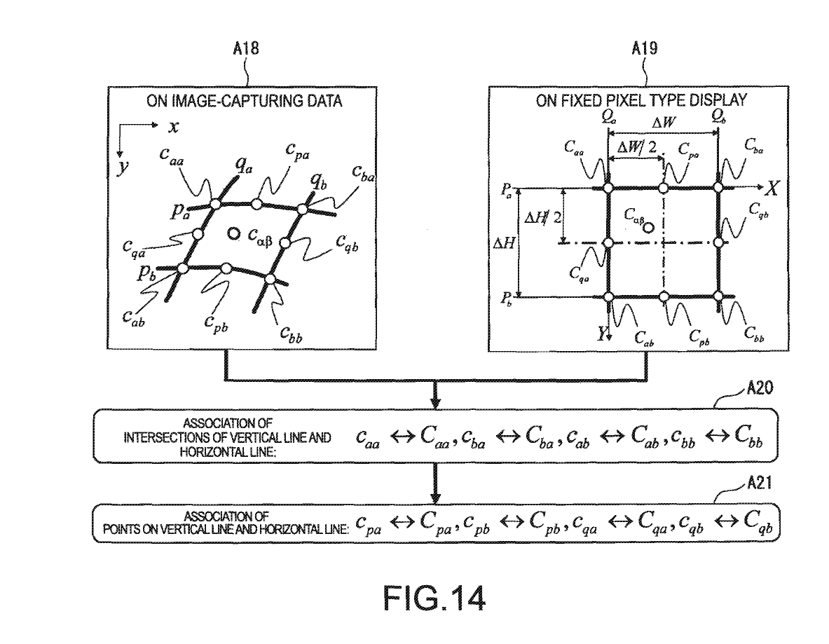

Further, in the first embodiment described above, the pixel mapping calculation unit 35 calculates the coordinate of the arbitrary point within the quadrilateral region using only the intersections of the vertical and horizontal lines. In contrast, the pixel mapping calculation unit 50 according to the second embodiment uses the intersections and center points of the vertical and horizontal lines in order to calculate the coordinate of the arbitrary point within the quadrilateral region, as shown in FIG. 14. This is different from the first embodiment.

Hereinafter, these differences will be described in detail.

First, as shown in FIG. 14, in order to calculate the interpolation function that provides the correspondence between an arbitrary point ca, within a quadrilateral region on image-capturing data shown in an image A18 and a point C_{αβ} on image data shown in a corresponding image A19, the pixel mapping calculation unit 50 uses center points cₚₐ, c_{pb}, c_{qa}, and c_{qb}, in addition to the intersections cₐₐ, c_{ab}, c_{ba}, and c_{bb} (A20) in the first embodiment. Then, the pixel mapping calculation unit 50 calculates the interpolation function by finding the correspondence between the center points cₚₐ, c_{pb}, c_{qa}, and c_{qb} and corresponding points cₚₐ, c_{pb}, cₐₐ, and c_{qb} on the image data (A21).

Here, an x coordinate of the point cₚₐ is set to a value obtained by equally dividing x coordinates of the intersections cₐₐ and c_{ba}, and a y coordinate thereof is calculated from an approximate function of horizontal line mapping data. The points c_{pb}, c_{qa}, and c_{qb} are similarly calculated.

As regards the positional coordinate (x, y) of the arbitrary point c_{αβ} within the quadrilateral region in the image capturing data using the intersections and the center points, if a coordinate value of a point cᵢⱼ is (xᵢⱼ, yᵢⱼ), the interpolation function is provided by the following expressions (13) and (14).

x=Nₐₐxₐₐ+N_{ba}x_{ba}+N_{ab}x_{ab}+N_{bb}x_{bb}+Nₚₐxₚₐ+N_{pb}x_{pb}+N_{qa}x_{qa}+N_{qb}x_{qb} (13)

y=Nₐₐyₐₐ+N_{ba}y_{ba}+N_{ab}y_{ab}+N_{bb}y_{bb}+Nₚₐyₚₐ+N_{pb}y_{pb}+N_{qa}y_{qa}+N_{qb}y_{qb} (14)

In the expressions (13) and (14), when a distance between the intersections Cₐₐ and C_{ba} of the image data shown in the image A19 is ΔW and the distance between the intersections Cₐₐ and C_{ab} is ΔH, the coefficients Nₐₐ, N_{ab}, N_{ba}, N_{bb}, Nₚₐ, N_{pb}, N_{qa}, and N_{qb} are found by the following expressions (15) to (22).

$$\begin{matrix}{N}_{aa} = \frac{Δ W - X}{Δ W} \frac{Δ H - Y}{Δ H} ( \frac{Δ H - 2 Y}{Δ H} - 2 \frac{X}{Δ W} ) & ( 15 ) \\ {N}_{ba} = - \frac{X}{Δ W} \frac{Δ H - Y}{Δ H} ( \frac{Δ H + 2 Y}{Δ H} - 2 \frac{X}{Δ W} ) & ( 16 ) \\ {N}_{ab} = - \frac{Δ W - X}{Δ W} \frac{Y}{Δ H} ( \frac{Δ H - 2 Y}{Δ H} + 2 \frac{X}{Δ W} ) & ( 17 ) \\ {N}_{bb} = - \frac{X}{Δ W} \frac{Y}{Δ H} ( \frac{3 Δ H - 2 Y}{Δ H} - 2 \frac{X}{Δ W} ) & ( 18 ) \\ {N}_{pa} = 4 \frac{X}{Δ W} \frac{Δ W - X}{Δ W} \frac{Δ H - Y}{Δ H} & ( 19 ) \\ {N}_{pb} = 4 \frac{X}{Δ W} \frac{Δ W - X}{Δ W} \frac{Y}{Δ H} & ( 20 ) \\ {N}_{qa} = 4 \frac{Δ W - X}{Δ W} \frac{Y}{Δ H} \frac{Δ H - Y}{Δ H} & ( 21 ) \\ {N}_{qb} = 4 \frac{X}{Δ W} \frac{Y}{Δ H} \frac{Δ H - Y}{Δ H} & ( 22 )\end{matrix}$$

In such a manner, the pixel mapping calculation unit 50 finds the interpolation function that provides the correspondence between the arbitrary position within the quadrilateral region mapped on the image-capturing data and the pixel position of the display image. Accordingly, the number of sample points for comparison increases, and thus the correspondence of the arbitrary position can be found with higher accuracy.

Next, the end-of-processing judging unit 49 generates pixel mapping data again when it is judged that the accuracy of the pixel mapping data found by the pixel mapping calculation unit 50 is not sufficient. Specifically, the end-of-processing judging unit 49 performs the judgment of the end of the processing on the basis of an evaluation value Error to be provided by the following expression (23). As regards the evaluation value Error, the above processing may be performed for all pixels. Further, N representative points may be set in advance, and then it may be judged how the evaluation value changes at the representative points.

$$Error = \frac{1}{N} {\sum }_{i = 0}^{N} \frac{\sqrt{{( {x}_{i}^{n} - {x}_{i}^{n - 1} )}^{2} + {( {y}_{i}^{n} - {y}_{i}^{n - 1} )}^{2}}}{\sqrt{{( {x}_{i}^{n} )}^{2} + {( {y}_{i}^{n} )}^{2}}} \qquad ( 23 )$$

Here, xᵢⁿ and yᵢⁿ represent a pixel position on image-capturing data of a pixel index i and an n-th loop, and xᵢⁿ⁻¹ and yᵢⁿ⁻¹ represent a pixel position on image-capturing data of a pixel index i and an (n−1)th loop.

The evaluation value Error is calculated as a difference between the pixel mapping data acquired multiple times. When the evaluation value Error is sufficiently small or when the difference between the evaluation value Error after the previous processing and the evaluation value Error after the latest processing is sufficiently small, the end-of-processing judging unit 49 ends the processing.

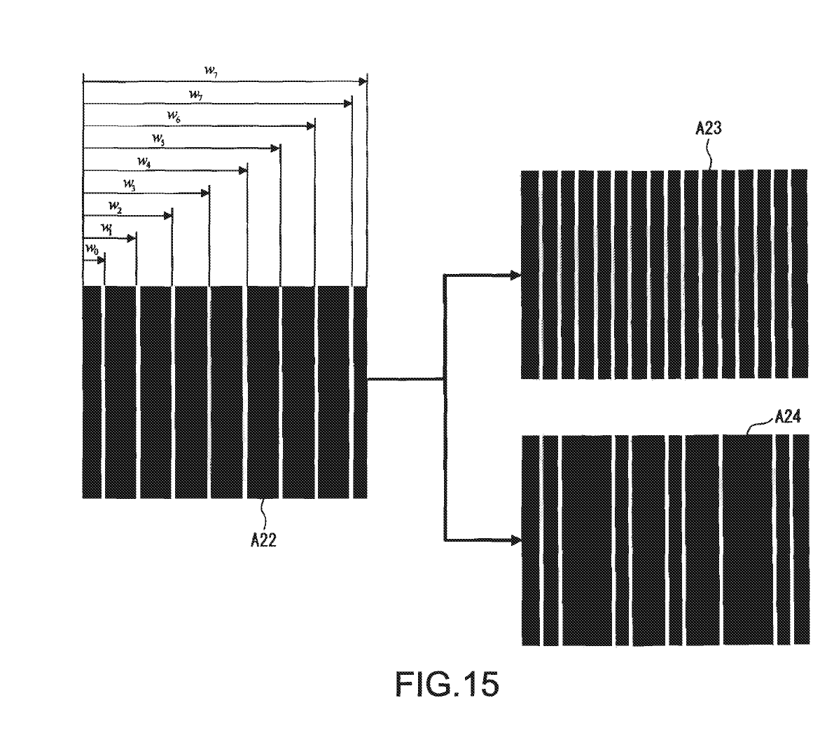

Meanwhile, when the end-of-processing judging unit 49 judges that the evaluation value Error is not sufficiently small or the difference from the previous time is large, as shown in FIG. 15, the end-of-processing judging unit 49 reconstructs image data in which a pitch of a vertical line of an initial vertical line display image A22 is set to 0.5 times, like an image A23, or image data in which a pitch of a vertical line is set to have an unequal interval, like an image A24. The reconstructed image data is input to the projector 100 and a display image is displayed on the basis of the reconstructed image data. The horizontal line image data is reconstructed in the same manner.

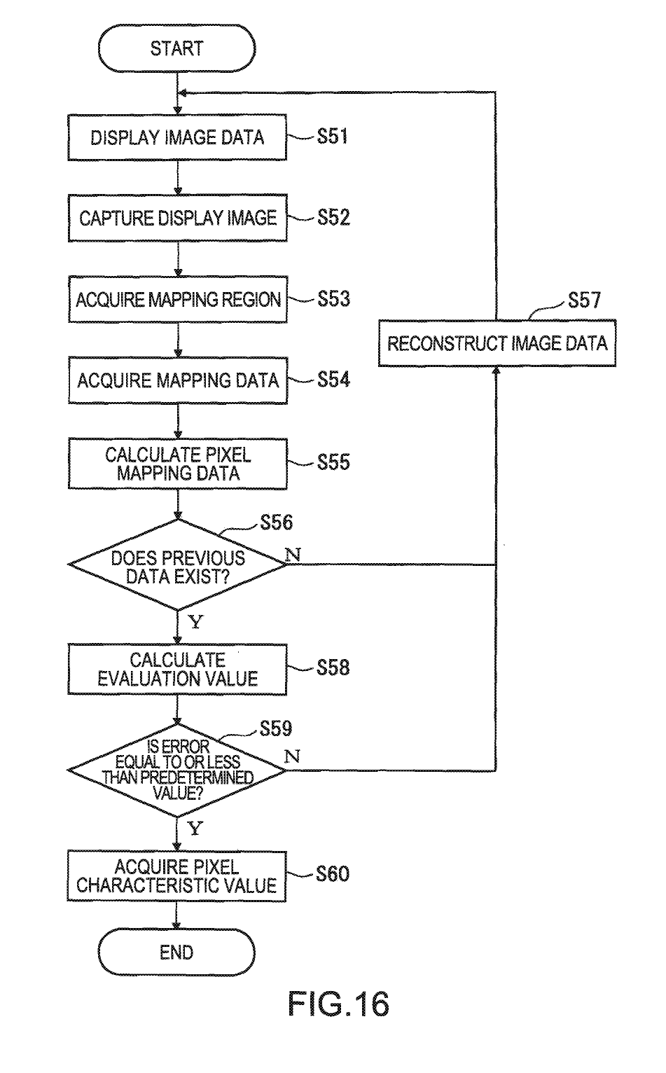

Next, the operation of the pixel characteristic value acquiring system 4 according to the second embodiment will be described with reference to a flowchart shown in FIG. 16.

(1) First, the display image forming unit 32 inputs the vertical line image data, the horizontal line image data, and the characteristic value acquisition image data to the protector 100, and causes the individual display images to be displayed on the screen 101 (Step S51). Then, the display image introducing unit 31 captures and introduces the individual display images (Step S52).

(2) Next, the mapping region acquiring unit 33 acquires the mapping region (Step S53), and the approximate function setting unit 34 acquires mapping data on the basis of the acquired mapping region (Step S54).

(3) Next, the pixel mapping calculation unit 50 calculates the pixel mapping data through the above-described processing (Step S55). These steps are the same as those in the first embodiment.

(4) The end-of-processing judging unit 49 judges whether or not the pixel mapping data calculated at the previous time exists (Step S56). When the pixel mapping data calculated an the previous time does not exist, the reconstruction of the image data, such as the image A23 or the image A24, is performed (Step S57), and the reconstructed image data is input to the projector 100. Then, Steps S51 to S55 are repeated.

(5) The end-of-processing judging unit 49 calculates the evaluation value Error based on the expression (23) on the basis of pixel mapping data based on the reconstructed image data obtained by repeating Steps S51 to S55 and the previous pixel mapping data (Step S58), and judges whether or not the evaluation value Error is equal to or less than a predetermined threshold value (Step S59).

(6) When it is judged that the evaluation value Error is not equal to or less than the predetermined threshold value, the end-of-processing judging unit 49 reconstructs the image data, such as the image A23 or the image A24, and inputs the reconstructed image data to the projector 100. Then, Steps S51 to S55 are repeated, and new pixel mapping data is calculated. Meanwhile, when it is judged that the evaluation value Error is equal to or less than the predetermined threshold value, the processing ends. Then, the pixel characteristic value acquiring unit 36 starts to acquire the pixel characteristic value based on the latest pixel mapping data (Step S60).

### Third Embodiment

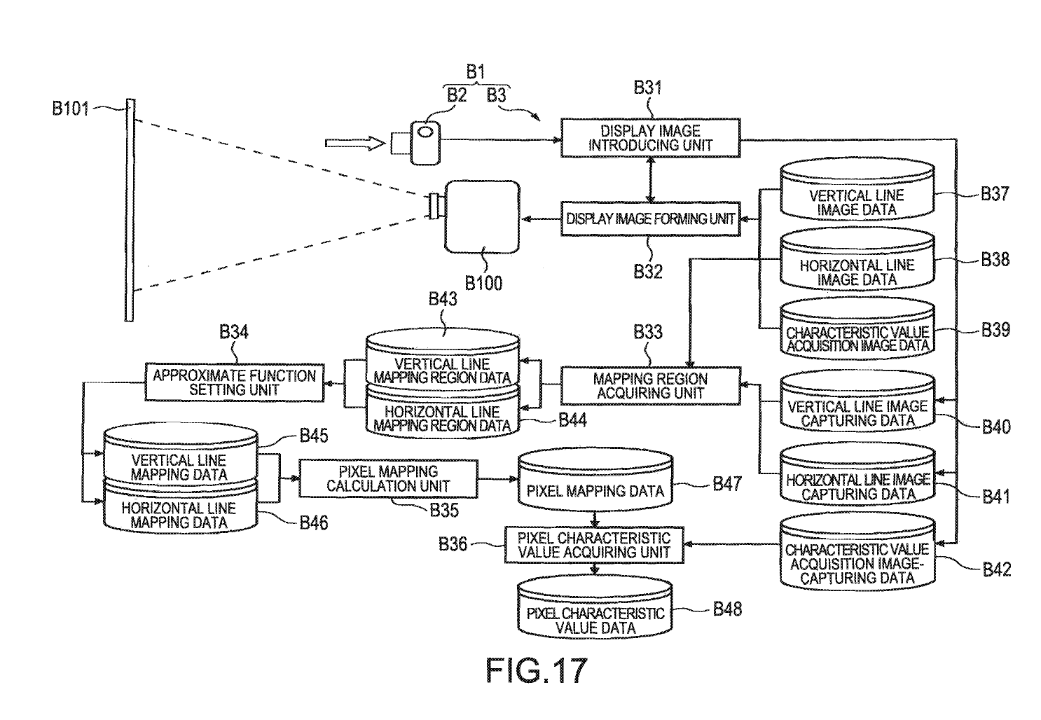

FIG. 17 shows a pixel characteristic value acquiring system B1 for executing a pixel position acquiring method according to a third embodiment of the invention. The pixel characteristic value acquiring system B1 acquires a pixel characteristic value, for example, luminance, chromaticity, or the like, for each pixel of a fixed pixel type display, such as a liquid crystal panel or the like, constituting a projector B100, and generates correction data for each pixel on the basis of the acquired pixel characteristic value. The pixel characteristic value acquiring system B1 includes an image-capturing device B2 and a computer B3.

As the image-capturing device B2, a CCD camera or a CMOS sensor is used. The image-capturing device B2 is disposed at a fixed position with respect to a screen B101 so as to capture a projection image on the basis of image data projected on the screen B101 and outputs acquired image-capturing data to the computer B3.

The computer B3 includes an arithmetic processing device and a storage device. The computer B3 processes the image-capturing data output from the image-capturing device B2, finds a correspondence between a pixel position on a display image displayed by the liquid crystal panel constituting the projector B100 and a position where the pixel position is mapped on the image-capturing data, and acquires the pixel characteristic value for each pixel. Specifically, the computer B3 includes a display image introducing unit B31, a display image forming unit B32, a mapping region acquiring unit B33, an approximate function setting unit B34, a pixel mapping calculation unit B35, and a pixel characteristic value acquiring unit B36. In the storage device, a vertical line image capturing data storage unit B40, a horizontal line image capturing data storage unit B41, a characteristic value acquisition image-capturing data storage unit B42, a vertical line mapping region data storage unit B43, a horizontal line mapping region data storage unit B44, a vertical line mapping data storage unit B45, a horizontal line mapping data storage unit B46, a pixel mapping data storage unit B47, and a pixel characteristic value data storage unit B48 that respectively store data to be acquired or generated by a vertical line image data storage unit B37, a horizontal line image data storage unit B38, a characteristic value acquisition image data storage unit B39, and other functional units, all of which are prepared in advance, are secured. Hereinafter, a processing that is performed by each of the functional units will be described in detail.

### 1. Processing in Display Image Introducing Unit B31 and Display Image Forming Unit B32

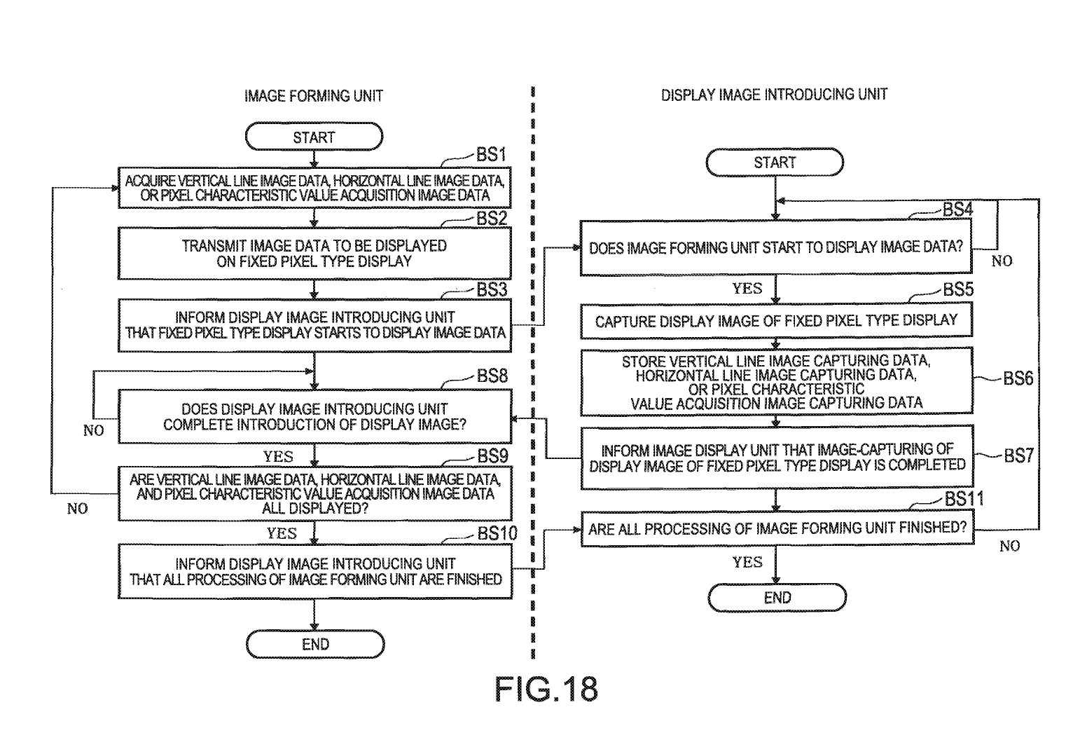

The display image introducing unit B31 and the display image forming unit B32 are a unit that outputs predetermined image data to the protector B100, from which a pixel characteristic value is to be acquired, causes a predetermined display image to be displayed on the screen B101 by the projector B100, captures the display image displayed on the screen B101 by the image-capturing device B2, and introduces the captured image as image-capturing data. Both units execute a series of steps shown in FIG. 18 together.

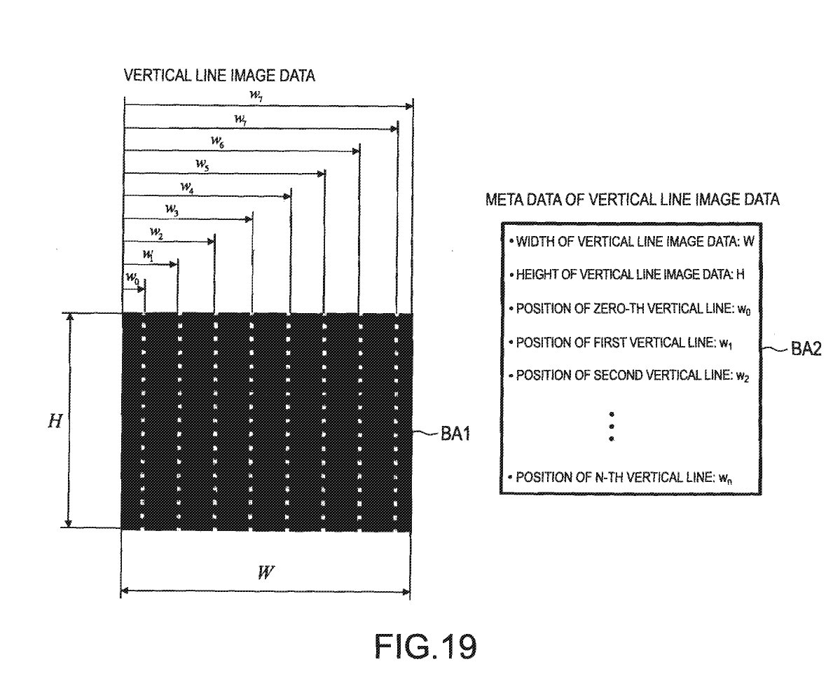

(1) First, the display image forming unit B32 reads out and acquires vertical line image data stored in the vertical line image data storage unit B37 (Step BS1), and transmits the acquired data to the projector 100 (Step BS2). Here, as shown in FIG. 19, the vertical line image data is an image BA1 in which a plurality of vertical lines extending in a vertical direction on the display image and subjected to a gradation in an extension direction are arranged with predetermined intervals in a horizontal direction. Actually, the vertical line image data is recorded in the vertical line image data storage unit B37 as meta data BA2 having a width W, a height H, a position w₀ of a zero-th vertical line, a position w₁ of first vertical line, a position w₂ of a second vertical line, . . . in the image data.

(2) The display image forming unit B32 subsequently informs the display image introducing unit B31 that the projector B100 starts to display the vertical line image data (Step BS3). When information purporting that image display is started is acquired from the display image forming unit B32 (Step BS4), the display image introducing unit B31 captures the display image by the image-capturing device B2 (Step BS5), introduces vertical line image capturing data into the computer B3, and stores the vertical line image capturing data in the vertical line image capturing data storage unit B40 (Step BS6).

(3) After the storage of the image-capturing data is finished, the display image introducing unit B31 subsequently informs the display image forming unit B32 of that purport (Step BS7). When information purporting that image-capturing is finished is acquired (Step BS8), the display image forming unit B32 starts to acquire next horizontal line image data (Step BS9).

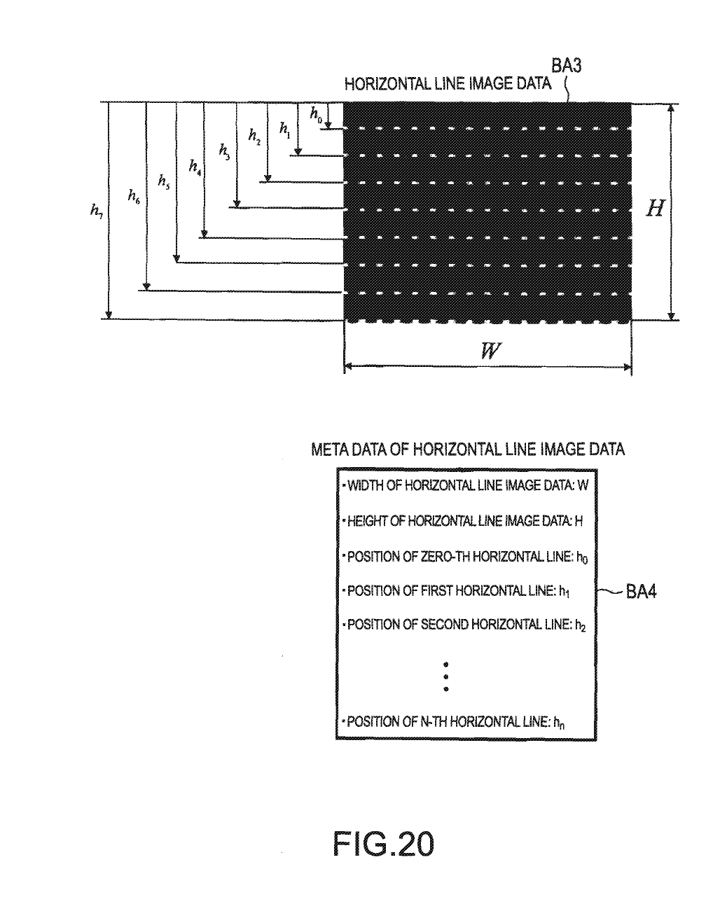

(4) Next, the display image forming unit B32 repeats the acquisition and display of horizontal line image data and the pixel characteristic value acquisition image data. Then, the display image introducing unit B31 sequentially stores image-capturing data of individual images in the horizontal line image capturing data storage unit B41 and the characteristic value acquisition image-capturing data storage unit B42. Moreover, as shown in FIG. 20, the horizontal line image data is an image BA3 in which a plurality of horizontal lines extending in the horizontal direction and subjected to the gradation in the extension direction are arranged with predetermined intervals in the vertical direction. The horizontal line image data storage unit B38 stores meta data BA4 having a width W, a height H, a position h₀ of a zero-th horizontal line, a position h₁ of a first horizontal line, a position h₂ of a second horizontal line, . . . in the image data. Further, though not shown, the pixel characteristic value acquisition image data has a luminance signal, a color signal, and the like for causing all pixels to display predetermined luminance, color, and the like. For example, the pixel characteristic value acquisition image data is stored in the characteristic value acquisition image data storage unit B39 as data for judging a variation in voltage transmission characteristic (VT-γ) of each pixel.

(5) The display image introducing unit B31 captures a display image displayed on the basis of the horizontal line image data by the image-capturing device B2, introduces the captured image as horizontal line image capturing data, and stores the horizontal line image capturing data in the horizontal line image capturing data storage unit B41. Further, the display image introducing unit B31 captures a display image displayed on the basis of the pixel characteristic value acquisition image data by the image-capturing device B2, introduces the captured image as characteristic value acquisition image-capturing data, and stores the characteristic value acquisition image-capturing data in the characteristic value acquisition image-capturing data storage unit B42.

(6) The display image forming unit B32 judges, on the basis of all image data described above, whether or not they are displayed on the projector B100 (Step BS9). If the display of all images is finished, the display image forming unit B32 in forms the display image introducing unit B31 of that purport (Step BS10).

(7) The display image introducing unit B313 judges whether or not information purporting that the image display is finished is acquired from the display image forming unit B32 (Step BS11). If the information purporting that the image display is finished is acquired, the display image introducing unit B31 ends the processing.

### 2. Processing in Mapping Region Acquiring Unit B33

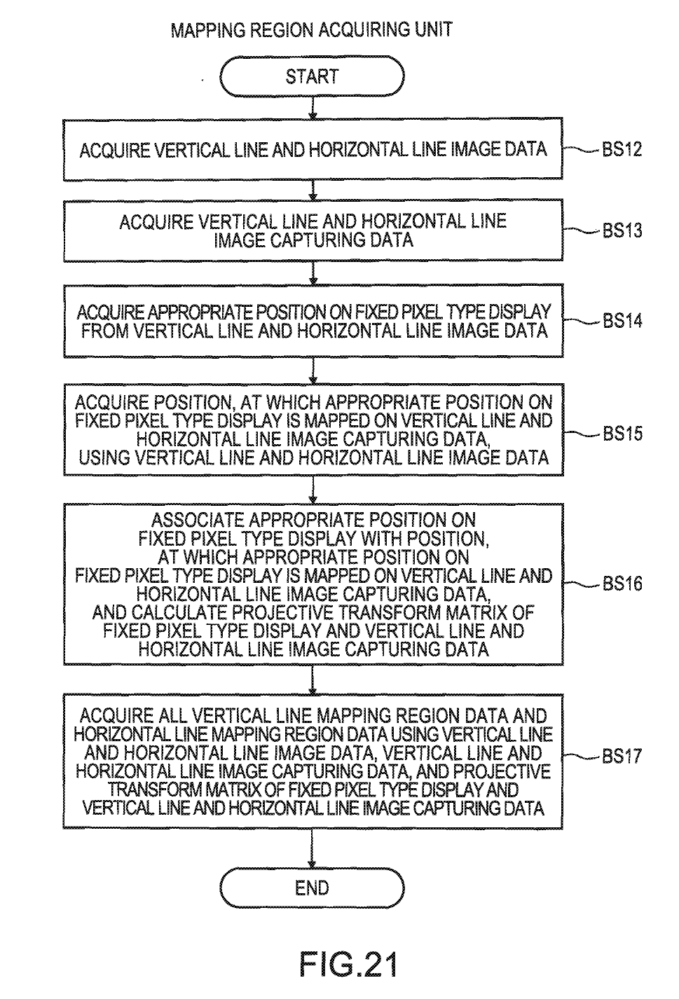

The mapping region acquiring unit B33 is a unit that finds a rough correspondence between the vertical line image data BA1 and the horizontal line image data BA3 and between the vertical line image capturing data and the horizontal line image capturing data obtained by capturing display images using the image-capturing device B2, and, on the basis of the correspondence, cuts each image-capturing line on the vertical line image capturing data and the horizontal line image capturing data. Specifically, the mapping region acquiring unit B33 performs a processing shown in FIG. 21.

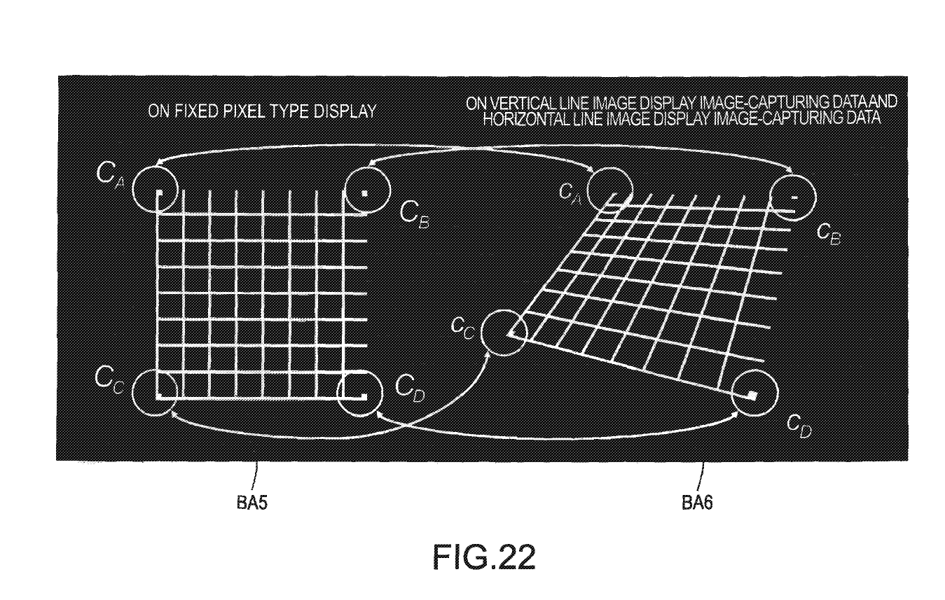

(1) First, the mapping region acquiring unit B33 acquires the vertical line image data BA1 stored in the vertical line image data storage unit B37 and the horizontal line image data BA3 stored in the horizontal line image data storage unit B38 (Step BS12). If the acquired vertical line image data and horizontal line image data are superimposed, as shown in FIG. 22, a lattice-shaped image BAS is obtained.

(2) Next, the mapping region acquiring unit B33 acquires the vertical line image capturing data stored in the vertical line image capturing data storage unit B40 and the horizontal line image capturing data stored in the horizontal line image capturing data storage unit B41 (Step BS13). If the acquired vertical line image capturing data and horizontal line image capturing data are superimposed, as shown in FIG. 22, the lattice-shaped image BA5 is deformed according to an image-capturing position of the image-capturing device B2 with respect to the screen B101, and then an image BA6 is acquired.

(3) The mapping region acquiring unit B33 acquires positions of markers C_{A}, C_{B}, C_{C}, and C_{D} at corners of the image BAS as the prescribed vertical line image data and horizontal line image data (Step BS4).

(4) Next, the mapping region acquiring unit B33 acquires mapping positions c_{A}, c_{B}, c_{C}, and c_{D} where the markers C_{A}, C_{B, C}_{C}, and C_{D} of the image BAS are mapped on the image BA6 as the image-capturing data (Step BS15).

(5) The mapping region acquiring unit B33 calculates a projective transform matrix on the basis of the correspondence between the markers C_{A}, C_{B}, C_{C}, and C_{D} and the mapping positions c_{A}, c_{B}, c_{C}, and c_{D} (Step BS16). Specifically, if an arbitrary constant w is set with respect to a vector (x, y)^{T} by incrementing a coordinate axis and a vector (wx, wy, w)^{T} is established, a projective transform can be expressed by a transform expression, for example, the following expression (24).

$$( \begin{matrix}wx \\ wy \\ w\end{matrix} ) = [ \begin{matrix}{a}_{0} & {a}_{1} & {a}_{2} \\ {a}_{3} & {a}_{4} & {a}_{5} \\ {a}_{6} & {a}_{7} & 1\end{matrix} ] ( \begin{matrix}WX \\ WY \\ W\end{matrix} ) \qquad ( 24 )$$

If the transform expression (24) is arranged to a general equation, and both sides are arranged, a mapping position coordinate (x, y) of each of the mapping positions c_{A}, c_{B}, c_{C}, and c_{D} is provided by the following expressions (25) and (26) using a marker coordinate (X, Y).

$$\begin{matrix}x = \frac{wx}{w} = \frac{{a}_{0} WX + {a}_{1} WY + {a}_{2} W}{{a}_{6} WX + {a}_{7} WY + W} = \frac{{a}_{0} X + {a}_{1} Y + {a}_{2}}{{a}_{6} X + {a}_{7} Y + 1} & ( 25 ) \\ y = \frac{wy}{w} = \frac{{a}_{3} WX + {a}_{4} WY + {a}_{5} W}{{a}_{6} WX + {a}_{7} WY + W} = \frac{{a}_{3} X + {a}_{4} Y + {a}_{5}}{{a}_{6} X + {a}_{7} Y + 1} & ( 26 )\end{matrix}$$

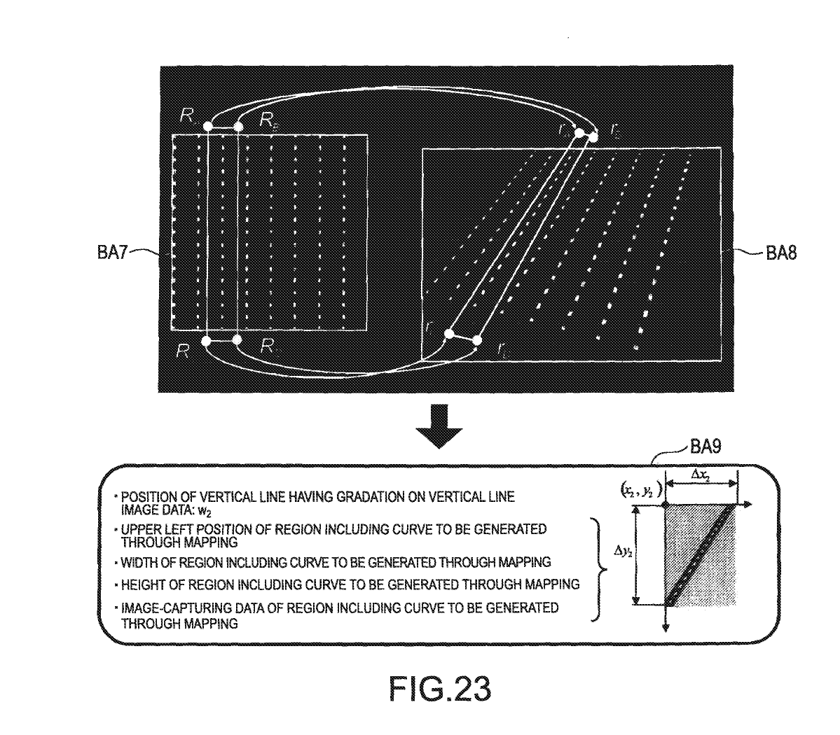

(6) After the correspondence between the mapping position coordinate (x, y) and the marker coordinate (X, Y) is found, the mapping region acquiring unit B33 performs a processing of cutting a vertical line on an image BA7 representing vertical line image data shown in FIG. 23 from the vertical line image data by surrounding the straight line with points R_{A}, R_{B}, R_{C}, and R_{D}. Then, the mapping region acquiring unit B33 finds coordinates (x, y) of points r_{A}, r_{B}, r_{C}, and r_{D} mapped on an image BA8 as vertical line image capturing data from the coordinates (X, Y) of the points R_{A}, R_{B}, R_{C}, and R_{D} through the expressions (25) and (26). Subsequently, the mapping region acquiring unit B33 cuts an image-capturing line on the image BA8 on the basis of the individual found coordinates and acquires vertical line mapping region data (Step BS17). In case of a third vertical line having a distance w₂ from a left end of the vertical line image data of FIG. 23, as shown in an image BA9, the acquired vertical line mapping reason data is image-capturing data according to a position w₂ on the vertical line image data, an upper left position (x₂, y₂) of a region including an image-capturing line to be generated through mapping to the vertical line image capturing data, a width Δx₂ of the region including the image-capturing line, a height Δy₂ of the region including the image-capturing line, and a region where the image-capturing line is surrounded with the points r_{A}, r_{B}, r_{C}, and r_{D}. The acquired vertical line mapping region data is stored in the vertical line mapping region data storage unit B43 for each image-capturing line. Moreover, horizontal line mapping region is found in the same manner as the vertical line and is stored in the horizontal line mapping region data storage unit B44 as the same data structure.

### 3. Processing in Approximate Function Setting Unit B34

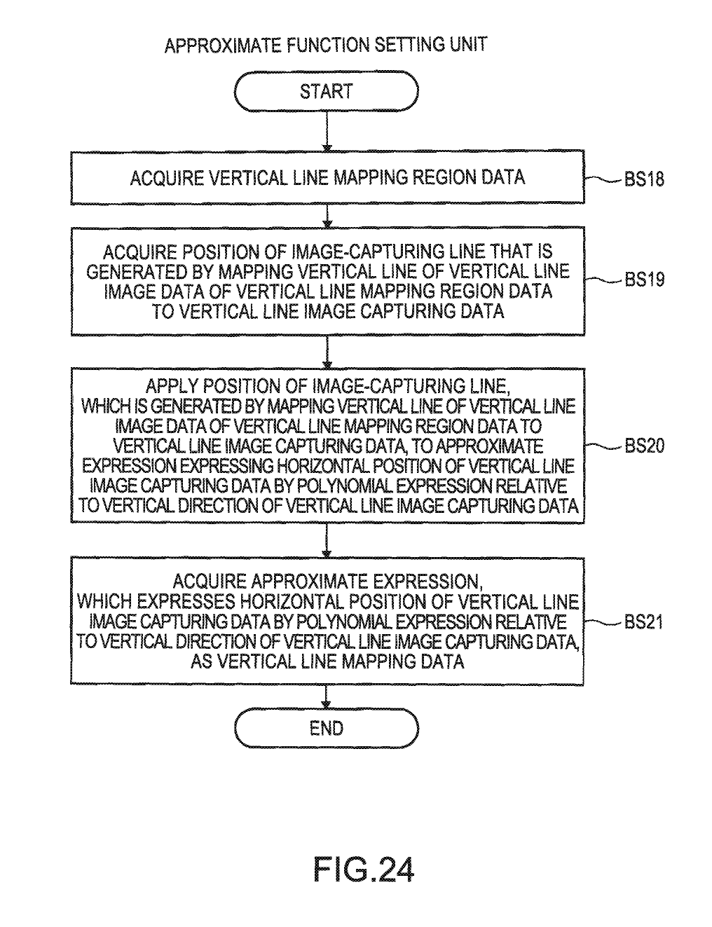

The approximate function setting unit B34 sets an approximate function representing each image-capturing line on the basis of the mapping region data stored in the vertical line mapping region data storage unit B43 and the horizontal line mapping region data storage unit B44. For example, in case of the vertical line mapping region data, a processing shown in a flowchart of FIG. 24 is performed so as to set the approximate function.

(1) First, the approximate function setting unit B34 acquires vertical line mapping region data from the vertical line mapping region data storage unit B43 (Step BS18).

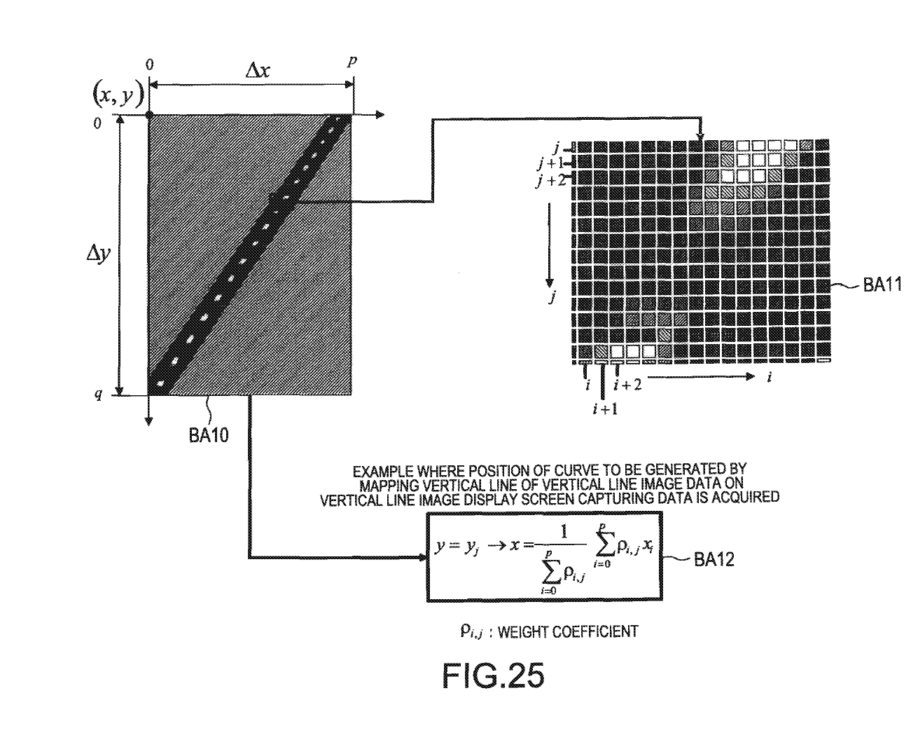

(2) Next, the approximate function setting unit B34 acquires the position of an image-capturing line to be generated through mapping of a vertical line of vertical line image data to vertical line image capturing data (Step SB19). As shown in FIG. 25, the acquisition of the position of the image-capturing line is performed by finding a spread range of a horizontal position x of the vertical line image capturing data at a vertical position y relative to vertical line mapping region data, such as an image BA10, and finding a representative value of the horizontal position x at the vertical position y on the basis of the spread range. Here, the representative value of the horizontal positions x is calculated using a weight coefficient ρᵢⱼ according to the image-capturing line by the following expression (27).

$$y = {y}_{j} -> x = \frac{1}{{\sum }_{i = 0}^{p} {ρ}_{i , j}} {\sum }_{i = 0}^{p} {ρ}_{i , j} {x}_{i} \qquad ( 27 )$$

Here, ρᵢⱼ is a weight coefficient.

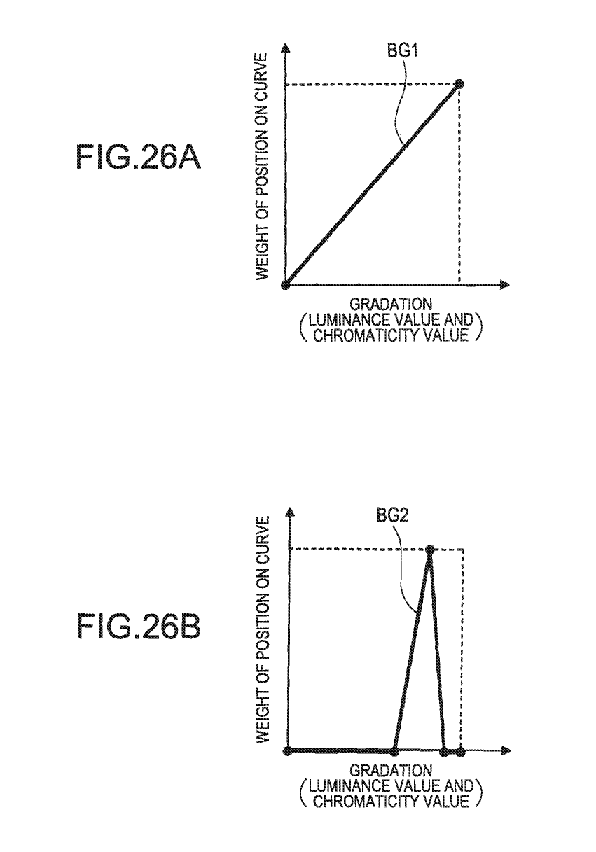

The weight coefficient ρᵢⱼ can be appropriately set. For example, like a graph BG1 shown in FIG. 26A, the weight coefficient may be set to linearly increase according to a degree of degradation. Further, like a graph BG2 shown in FIG. 26B, the weight coefficient may be set to increase at a specified grayscale level. In the latter case, since the weight coefficient at the specified gray-scale level increases, even though a white saturation region occurs in the image-capturing data due to saturation of the image-capturing device B2, it is not recognized as the vertical line.

Next, in such a manner, for all vertical positions y in the vertical line image capturing data, a group of data (x, y) providing an image-capturing line, such as BA12 of FIG. 25, is acquired.

(3) Next, the approximate function setting unit B34 applies the position of the image-capturing line, which is generated through mapping of the vertical line of the vertical line image data in the vertical line mapping region data to the vertical line image capturing data, to the approximate function that represents a horizontal position X of the vertical line image capturing data by a polynomial expression about a vertical direction Y of the vertical line image capturing data (Step BS20). Specifically, as regards the approximate function, when the horizontal position X is expressed by a polynomial expression of the vertical position Y, and when an order of the polynomial expression is M, the number of positional coordinates on the image-capturing line is N, a horizontal component of image-capturing data of a positional coordinate on the image-capturing line is x, a vertical component of image-capturing data of the positional coordinate on the image-capturing line is y, an average of the horizontal components of the image-capturing data of the positional coordinate on the image-capturing line is σₓ, an average of the vertical components of the image-capturing data on the image-capturing line is σ_{y}, a standard deviation of the horizontal components of the image-capturing data of the positional coordinate on the image-capturing line is σₓ, and a standard deviation of the vertical components of the image-capturing data on the image-capturing line is σ_{y}, the relationship between the horizontal position X and the vertical position Y is provided by the following expression (28).

$$X = {\sum }_{j = 0}^{M} {A}_{j} {Y}^{j} \qquad ( 28 )$$

Here, X, Y, μₓ, and μ_{y} are defined as follows, respectively.

$$X = \frac{x - {μ}_{x}}{{σ}_{x}}$$

$$Y = \frac{y - {μ}_{y}}{{σ}_{y}}$$

$${μ}_{x} = \frac{1}{N} {\sum }_{n = 0}^{N} {x}_{n} , {σ}_{x}^{2} = \frac{1}{N} {\sum }_{n = 0}^{N} {( {x}_{n} - {μ}_{x} )}^{2}$$

$${μ}_{y} = \frac{1}{N} {\sum }_{n = 0}^{N} {y}_{n} , {σ}_{y}^{2} = \frac{1}{N} {\sum }_{n = 0}^{N} {( {y}_{n} - {μ}_{y} )}^{2}$$

(4) Finally, the approximate function setting unit B34 acquires the obtained approximate expression (28) as vertical line mapping data, together with the vertical line position w on the vertical line image data and stores the acquires the vertical line mapping data in the vertical line mapping data storage unit B45 (Step BS21).

In case of the horizontal line mapping region data, horizontal line mapping data is acquired in the same manner as the vertical line mapping region data. In this case, however, when a group of data corresponding to the image BA10 is acquired, a spread range of the vertical position y with respect to each horizontal position x is found and the representative value of the vertical positions y is found as a weighted average based on the weight coefficient according to the image-capturing line. Then, the vertical position Y is expressed by a polynomial expression of the horizontal position X. Specifically, the following expression (29) is provided, and the obtained approximate expression (29) is stored in the horizontal line mapping data storage unit B46, together with a horizontal line position h of the horizontal line image data.

$$Y = {\sum }_{i = 0}^{M} {A}_{i} {Y}^{i} \qquad ( 29 )$$

Here, X, Y, u, and key are defined as follows, respectively.

$$X = \frac{x - {μ}_{x}}{{σ}_{x}}$$

$$Y = \frac{y - {μ}_{y}}{{σ}_{y}}$$

$${μ}_{x} = \frac{1}{N} {\sum }_{n = 0}^{N} {x}_{n} , {σ}_{x}^{2} = \frac{1}{N} {\sum }_{n = 0}^{N} {( {x}_{n} - {μ}_{x} )}^{2}$$

$${μ}_{y} = \frac{1}{N} {\sum }_{n = 0}^{N} {y}_{n} , {σ}_{y}^{2} = \frac{1}{N} {\sum }_{n = 0}^{N} {( {y}_{n} - {μ}_{y} )}^{2}$$

### 4. Processing in Pixel Mapping Calculation Unit B35

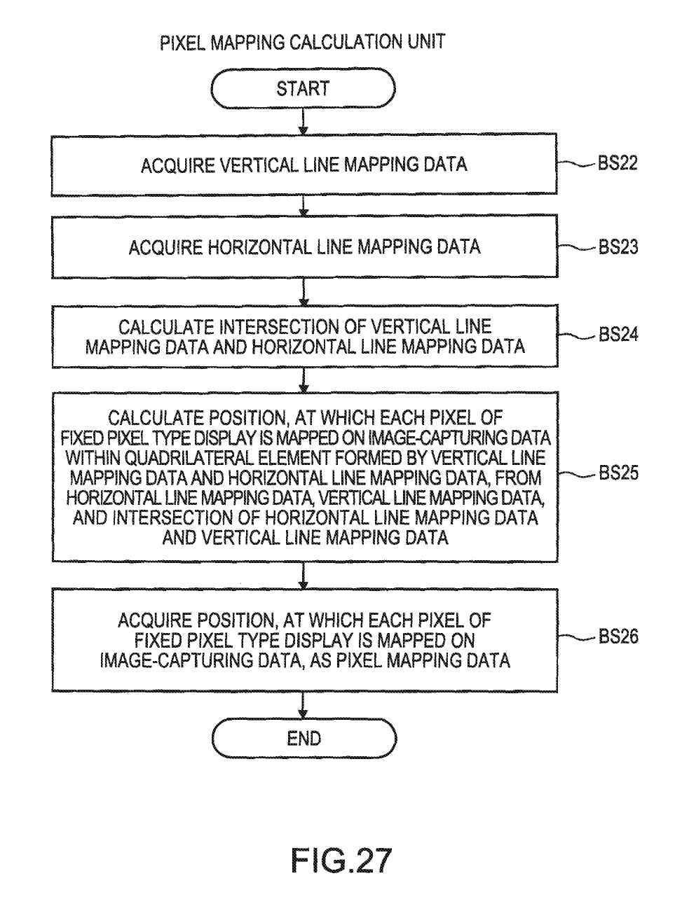

The pixel mapping calculation unit B35 calculates, on the basis of the vertical line mapping data and the horizontal line mapping data obtained by the approximate function setting unit B34, to which of the image-capturing data a pixel position of a display image displayed by a liquid crystal panel constituting the projector B100 or the like is mapped. Specifically, the pixel mapping calculation unit B35 performs a processing shown in a flowchart of FIG. 27.

(1) First, the pixel mapping calculation unit B35 acquires the vertical line mapping data stored in the vertical line mapping data storage unit B45 (Step BS22), and subsequently acquires the horizontal line mapping data stored in the horizontal line mapping data storage unit B46 (Step BS23).

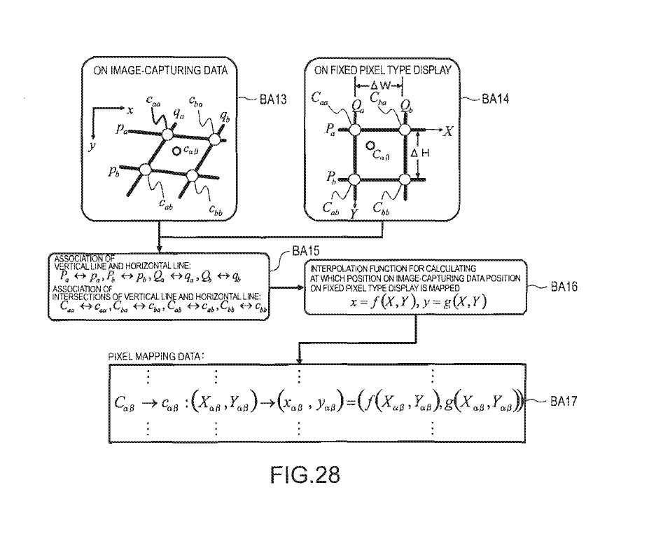

(2) Next, the pixel mapping calculation unit B35 calculates an intersection of the vertical line mapping data and the horizontal line mapping data (Step BS24), and calculates, from the horizontal line mapping data, the vertical line mapping data, and the intersection thereof, a position where each pixel position of the display image displayed by the liquid crystal panel of the fixed pixel type display or the like is mapped on the image-capturing data within a quadrilateral region defined by the vertical mine mapping data and the horizontal line mapping data (Step BS25). Specifically, in this embodiment, as shown in FIG. 28 intersections cₐₐ, c_{ab}, c_{ba}, and c_{bb} (Image BA13) of image-capturing lines pₐ and p_{b} on the horizontal line image capturing data and image-capturing lines qₐ and q_{b} on the vertical line image capturing data are respectively associated with intersections Cₐₐ, C_{ab}, C_{ba}, and C_{bb} (Image BA14) of horizontal lines Pₐ and P_{b} on the horizontal line image data displayed by the liquid crystal panel of the fixed pixel type display or the like and vertical lines Qₐ and Q_{b} on the vertical line image data (BA15). Then, the pixel mapping calculation unit B35 calculates by which interpolation function a position (x, y) of the image-capturing data is mapped to a pixel position (X, Y) of the display image (BA16) from the correspondence of respective intersections.

(3) As regards the calculation of the interpolation function by the pixel mapping calculation unit B35, specifically, a coordinate (x, y) of an arbitrary point cal within the quadrilateral region in the image BA13 can be expressed by the following expressions (30) and (31) using a coordinate (xₐₐ, yₐₐ) of the intersection cₐₐ, a coordinate (x_{ab}, y_{ab}) of the intersection c_{ab}, a coordinate (x_{ba}, y_{ba}) of the intersection c_{ba}, and a coordinate (x_{bb}, y_{bb}) of the intersection c_{bb}.

x=Nₐₐxₐₐ+N_{ba}x_{ba}+N_{ab}x_{ab}+N_{bb}x_{bb} (30)

y=Nₐₐyₐₐ+N_{ba}y_{ba}+N_{ab}y_{ab}+N_{bb}y_{bb} (31)

Here, when a horizontal distance between the intersections Cₐₐ and C_{ba} in the quadrilateral region of the display image is ΔW, and a vertical distance between the intersections C_{ba} and C_{bb} is ΔH, coefficients Nₐₐ, N_{ba}, N_{ab} and N_{bb} are provided by the following expressions (32) to (35), respectively. Accordingly, the coordinate (x, y) of the arbitrary point c_{αβ} within the quadrilateral region mapped on the image-capturing data shown in the image BA13 can be expressed as a coordinate (X, Y) of a corresponding point C_{αβ} of the quadrilateral region on the display image shown in the image BA4. Then, the interpolation function that provides the correspondence between the pixel position on the display image and the mapping position where the pixel position is mapped on the image-capturing data can be calculated.

$$\begin{matrix}{N}_{aa} = \frac{Δ W - X}{Δ W} \frac{Δ H - Y}{Δ H} & ( 32 ) \\ {N}_{ba} = \frac{X}{Δ W} \frac{Δ H - Y}{Δ H} & ( 33 ) \\ {N}_{ab} = \frac{Δ W - Y}{Δ W} \frac{Y}{Δ H} & ( 34 ) \\ {N}_{bb} = \frac{X}{Δ W} \frac{Y}{Δ H} & ( 35 )\end{matrix}$$

(4) In such a manner, the pixel mapping calculation unlit B35 calculates the interpolation function that provides the correspondence between all arbitrary mapping positions within the quadrilateral region mapped on the image-capturing data and all arbitrary pixel positions within the quadrilateral region on the display image, and stores the calculated interpolation function in the pixel mapping data storage unit B47 as pixel mapping data (Step BS26).

### 5. Processing in Pixel Characteristic Value Acquiring Unit B36

The pixel characteristic value acquiring unit B36 acquires a characteristic value of each pixel on the display image on the basis of the characteristic value acquisition image-capturing data stored in the characteristic value acquisition image-capturing data storage unit B42 and the pixel mapping data stored in the pixel mapping data storage unit B47. The pixel characteristic value acquiring unit B36 acquires the pixel characteristic value as follows.

(1) First, the pixel characteristic value acquiring unit B36 acquires the characteristic value acquisition image-capturing data from the characteristic value acquisition image-capturing data storage unit B42 and acquires the characteristic value on the image-capturing data. As the characteristic value, numeric data, such as a luminance value, color irregularity, and the like, is provided.

(2) Next, the pixel characteristic value acquiring unit B36 acquires the pixel mapping data from the pixel mapping data storage unit B47, and acquires, on the basis of the correspondence between each pixel position on the display image and the mapping position where the pixel position is mapped on the image-capturing data, characteristic value data, such as the luminance value, color irregularity, and the like, of a position where the pixel position is mapped on the image-capturing data.

(3) Finally, the pixel characteristic value acquiring unit B36 stores the characteristic value data according to all pixel positions on the display image in the pixel characteristic value data storage unit B48 as pixel characteristic value data.

### 6. Operation of the Embodiment

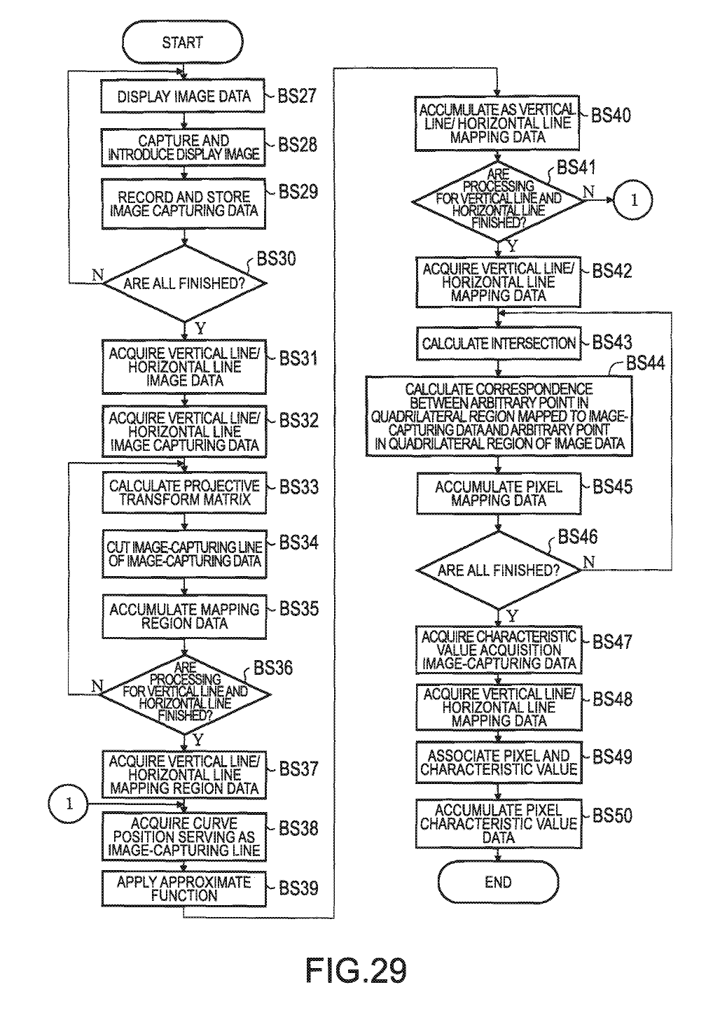

Next, an overall flow of the pixel characteristic value acquiring method to be executed by the above-described individual functional units will be described with reference to a flowchart shown in FIG. 29.

(1) The display image forming unit B32 causes images based on the vertical line image data, the horizontal line image data, and the characteristic value acquisition image data to be sequentially displayed on the projector B100 (Step BS27). Then, the display image forming unit B32 captures the display image displayed on the screen B101 according to each image data by the image-capturing device B2 and the captured images are sequentially introduced as image-capturing data by the display image introducing unit B31 (Step BS28). Subsequently, the image-capturing data is recorded and stored in the vertical line image capturing data storage unit B40, the horizontal line image capturing data storage unit B41, and the characteristic value acquisition image-capturing data storage unit B42 (Step BS29).

(2) When it is judged that the introduction of all image-capturing data by the display image introducing unit B31 is finished (Step BS30), the mapping region acquiring unit B33 acquires the vertical line image data and the horizontal line image data (Step BS31), and acquires the vertical line image capturing data and the horizontal line image capturing data (Step B532).

(3) The mapping region acquiring unit B33 first grasps to which position on the vertical line image capturing data the marker position set on the vertical line image data is mapped and calculates the expressions (25) and (26) representing the correspondence between the marker position and the mapping position (Step BS33). After the expressions (25) and (26) are calculated, the mapping region acquiring unit B33 sets a region surrounding a straight line to be set on the vertical line image data and cuts each image-capturing line from a region mapped on the image-capturing data transformed by the expressions (25) and (26) on the basis of the set region (Step BS34). Then, the obtained vertical line mapping region data is stored in the vertical line mapping region data storage unit B43 (Step BS35).

(4) Similarly, for the horizontal line image data and the horizontal line image capturing data, each image-capturing line on the image-capturing data is cut on the basis of the expressions (25) and (26) and is stored as the horizontal line mapping region data. This processing is repeated until the mapping region data is acquired for all image-capturing lines of the vertical and horizontal lines (Step BS36).

(5) After the acquisition of the mapping region data by the mapping region acquiring unit B33 is finished, the approximate function setting unit B34 acquires the vertical line mapping region data and the horizontal line mapping region data (Step BS37).

(6) The mapping region acquiring unit B33 acquires the position of a curve providing each image-capturing line stored as the vertical line mapping region data (Step BS38), and subsequently applies an approximate function of the polynomial expression to be provided by the expressions (28) and (29) that approximate the curve (Step BS39).

(7) The obtained approximate function is stored in the vertical line mapping data storage unit B45 as the vertical line mapping data (Step BS40).

(8) The mapping region acquiring unit B33 sets an approximate function in the same manner using the expression (29) for applying an image-capturing line in the horizontal line mapping data for the horizontal line mapping region data. If the setting of the approximate function and the storage of the mapping data for all image-capturing lines on the mapping region data are finished (Step B541), the processing ends.

(9) Next, the pixel mapping calculation unit B35 acquires the vertical line mapping data and the horizontal line mapping data (Step BS42), and calculates an intersection of a vertical line image-capturing line and a horizontal line image-capturing line on the basis of the approximate function providing each vertical line mapping data and the approximate function providing each horizontal line mapping data (Step BS43).

(10) The pixel mapping calculation unit B35 calculates, on the basis of the expressions (30) and (31), an interpolation function providing the correspondence between an arbitrary point within a quadrilateral region to be generated by the vertical line mapping data and the horizontal line mapping data and a point within the quadrilateral region by the vertical line image data and the horizontal line image data corresponding to the arbitrary point (Step BS44).

(11) The pixel mapping calculation unit B35 stores the calculated interpolation function as the pixel mapping data (Step BS45). The processing is repeated until the interpolation functions are found for all regions within the vertical and horizontal lines (Step BS46).

(12) After the calculation of the interpolation function by the pixel mapping calculation unit B35 is finished, the pixel characteristic value acquiring unit B36 acquires the characteristic value acquisition image-capturing data from the characteristic value acquisition image-capturing data storage unit B42 (Step BS47) and acquires the pixel mapping data from the pixel mapping data storage unit B47 (Step BS48). Then, each pixel on the display image is associated with the characteristic value (Step BS49), and the association is stored in the pixel characteristic value data storage unit B48 as the pixel characteristic value data (Step BS50).

According to this embodiment, the vertical line image data and the horizontal line image data are used as the pixel position acquisition image data. Accordingly, a complex distortion that occurs between the pixel position on the display image and the position where the pixel position is mapped on the image-capturing data due to the image-capturing device B2 can be grasped as the approximate function with high accuracy. Therefore, the correspondence between the pixel position of the display image and the position where the pixel position is mapped to the image-capturing data can be acquired with high accuracy.

Further, since the correspondence can be grasped with high accuracy by the above expressions (24) to (35), the correspondence can be simply found with high accuracy without performing a complex arithmetic processing.

### Fourth Embodiment

Next, a fourth embodiment of the invention will be described. Moreover, in the following description, the same parts as those described above are represented by the same reference numerals, and the descriptions thereof will be omitted.

In the third embodiment described above, the pixel mapping data is calculated by the pixel mapping calculation unit B35, and then the pixel characteristic value is immediately acquired by the pixel characteristic value acquiring unit B36.

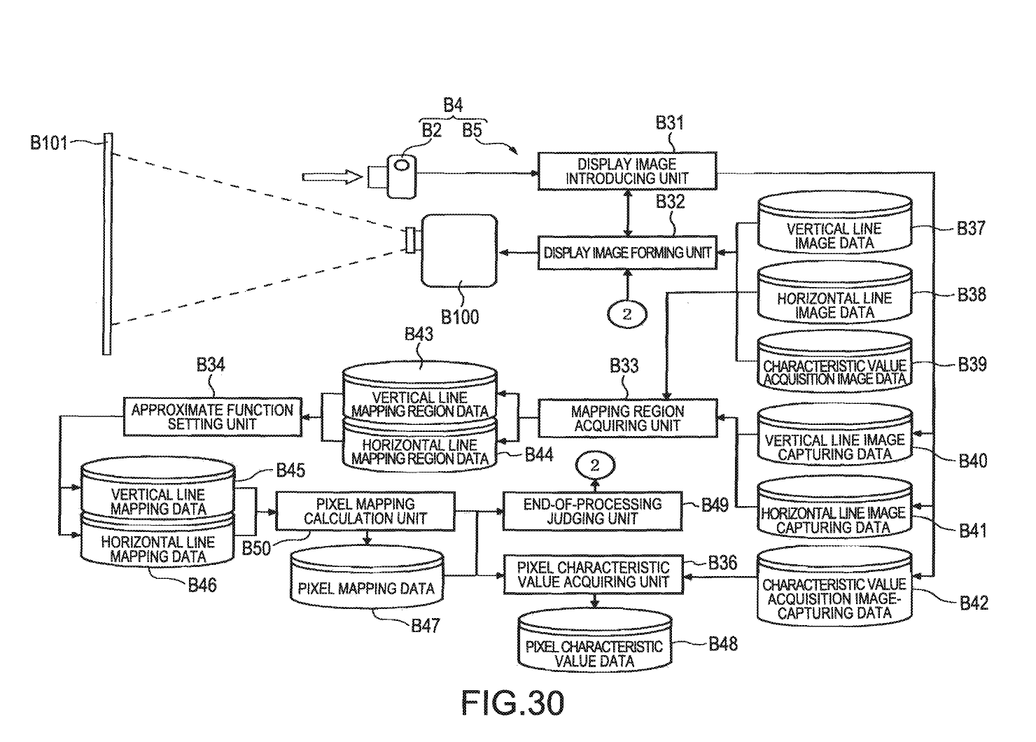

In contrast, in a pixel characteristic value acquiring system B4 according to the fourth embodiment, as shown in FIG. 30, an end-of-processing judging unit B49 is provided in a computer B5. Then, when it is judged that the pixel mapping data is not appropriate, display and introduction of the image data are performed again, and the pixel mapping data is calculated by a pixel mapping calculation unit B50. This processing is repeated until appropriate pixel mapping data is obtained. These are different from the third embodiment.

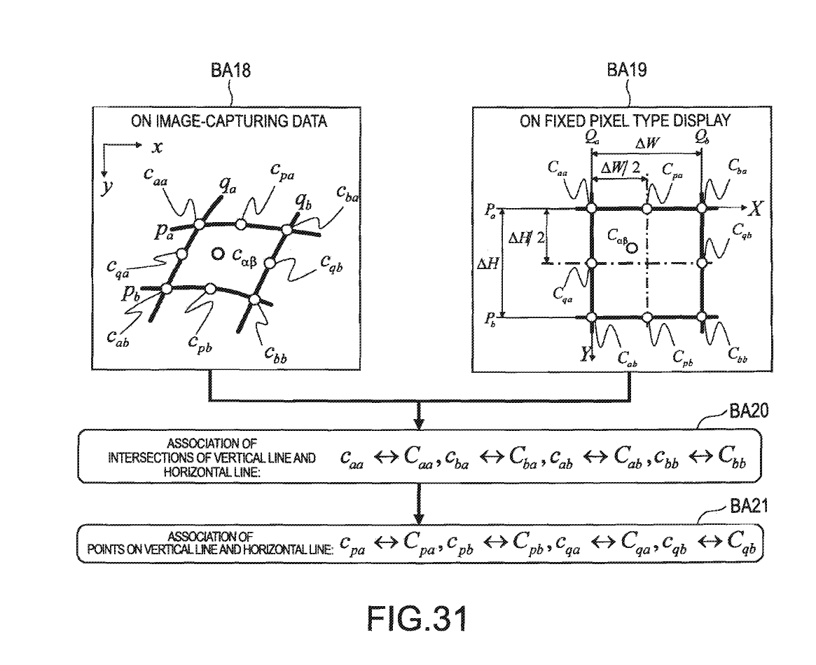

Further, in the third embodiment described above, the pixel mapping calculation unit B35 calculates the coordinate of the arbitrary point within the quadrilateral region using only the intersections of the vertical and horizontal lines. In contrast, the pixel mapping calculation unit B50 according to the fourth embodiment uses the intersections and center points of the vertical and horizontal lines in order to calculate the coordinate of the arbitrary point within the quadrilateral region, as shown in FIG. 31. This is different from the third embodiment.

Hereinafter, these differences will be described in detail.

First, as shown in FIG. 31, in order to calculate the interpolation function that provides the correspondence between an arbitrary point c_{αβ} within a quadrilateral region on image-capturing data shown in an image BA18 and a point C_{αβ} on image data shown in a corresponding image BA19, the pixel mapping calculation unit B50 uses center points cₚₐ, c_{pb}, c_{qa}, and c_{qb} of respective intersections, in addition to the intersections cₐₐ, c_{ab}, c_{ba}, and c_{bb} (BA20) in the third embodiment. Then, the pixel mapping calculation unit B50 calculates the interpolation function by finding the correspondence between the center points cₚₐ, c_{pb}, c_{qa}, and c_{qb} and corresponding points Cₚₐ, C_{pb}, C_{qa}, and C_{qb} on the image data (BA21).

Here, an x coordinate of the point cₚₐ is set to a value obtained by equally dividing x coordinates of the intersections cₐₐ and c_{ba}, and a y coordinate thereof is calculated from an approximate function of horizontal line mapping data. The points c_{pb}, c_{qa}, and c_{qb} are similarly calculated.

As regards the positional coordinate (x, y) of the arbitrary point c_{αβ} within the quadrilateral region in the image capturing data using the intersections and the center points, if a coordinate value of a point cᵢⱼ is (x_{ij, y}ᵢⱼ), the interpolation function is provided by the following expressions (36) and (37).

x=Nₐₐxₐₐ+N_{ba}x_{ba}+N_{ab}x_{ab}+N_{bb}x_{bb}+Nₚₐxₚₐ+N_{pb}x_{pb}+N_{qa}x_{qa}+N_{qb}x_{qb} (13)

y=Nₐₐyₐₐ+N_{ba}y_{ba}+N_{ab}y_{ab}+N_{bb}y_{bb}+Nₚₐyₚₐ+N_{pb}y_{pb}+N_{qa}y_{qa}+N_{qb}y_{qb} (14)

In the expressions (36) and (37), when a distance between the intersections Cₐₐ and C_{ba} of the image data shown in the image BA19 is ΔW and the distance between the intersections Cₐₐ and C_{ab} is ΔH, the coefficients Nₐₐ, N_{ab}, N_{ba}, N_{bb}, Nₚₐ, N_{pb}, N_{qa}, and N_{qb} are found by the following expressions (38) to (45).

$$\begin{matrix}{N}_{aa} = \frac{Δ W - X}{Δ W} \frac{Δ H - Y}{Δ H} ( \frac{Δ H - 2 Y}{Δ H} - 2 \frac{X}{Δ W} ) & ( 38 ) \\ {N}_{ba} = - \frac{X}{Δ W} \frac{Δ H - Y}{Δ H} ( \frac{Δ H + 2 Y}{Δ H} - 2 \frac{X}{Δ W} ) & ( 39 ) \\ {N}_{ab} = - \frac{Δ W - X}{Δ W} \frac{Y}{Δ H} ( \frac{Δ H - 2 Y}{Δ H} + 2 \frac{X}{Δ W} ) & ( 40 ) \\ {N}_{bb} = - \frac{X}{Δ W} \frac{Y}{Δ H} ( \frac{3 Δ H - 2 Y}{Δ H} - 2 \frac{X}{Δ W} ) & ( 41 ) \\ {N}_{pa} = 4 \frac{X}{Δ W} \frac{Δ W - X}{Δ W} \frac{Δ H - Y}{Δ H} & ( 42 ) \\ {N}_{pb} = 4 \frac{X}{Δ W} \frac{Δ W - X}{Δ W} \frac{Y}{Δ H} & ( 43 ) \\ {N}_{qa} = 4 \frac{Δ W - X}{Δ W} \frac{Y}{Δ H} \frac{Δ H - Y}{Δ H} & ( 44 ) \\ {N}_{qb} = 4 \frac{X}{Δ W} \frac{Y}{Δ H} \frac{Δ H - Y}{Δ H} & ( 45 )\end{matrix}$$

In such a manner, the pixel mapping calculation unit B50 finds the interpolation function that provides the correspondence between the arbitrary position within the quadrilateral region mapped on the image-capturing data and the pixel position of the display image. Accordingly, the number of sample points for comparison increases, and thus the correspondence of the arbitrary position can be found with higher accuracy.

Next, the end-of-processing judging unit B49 generates pixel mapping data again when it is judged that the accuracy of the pixel mapping data found by the pixel mapping calculation unit B50 is not sufficient. Specifically, the end-of-processing judging unit B49 performs the judgment of the end of the processing on the basis of an evaluation value Error to be provided by the following expression (46). As regards the evaluation value Error, the above processing may be performed for all pixels. Further, N representative points may be set in advance, and then it may be judged how the evaluation value changes at the representative points.

$$Error = \frac{1}{N} {\sum }_{i = 0}^{N} \frac{\sqrt{{( {x}_{i}^{n} - {x}_{i}^{n - 1} )}^{2} + {( {y}_{i}^{n} - {y}_{i}^{n - 1} )}^{2}}}{\sqrt{{( {x}_{i}^{n} )}^{2} + {( {y}_{i}^{n} )}^{2}}} \qquad ( 46 )$$

Here, xᵢⁿ and yᵢⁿ represent a pixel position on image-capturing data of a pixel index i and an n-th loop, and xᵢⁿ⁻¹ and yᵢⁿ⁻¹ represent a pixel position on image-capturing data of a pixel index i and an (n−1)th loop.

The evaluation value Error is calculated as a difference between the pixel mapping data acquired multiple times. When the evaluation value Error is sufficiently small or when the difference between the evaluation value Error after the previous processing and the evaluation value Error after the latest processing is sufficiently small, the end-of-processing judging unit B49 ends the processing.

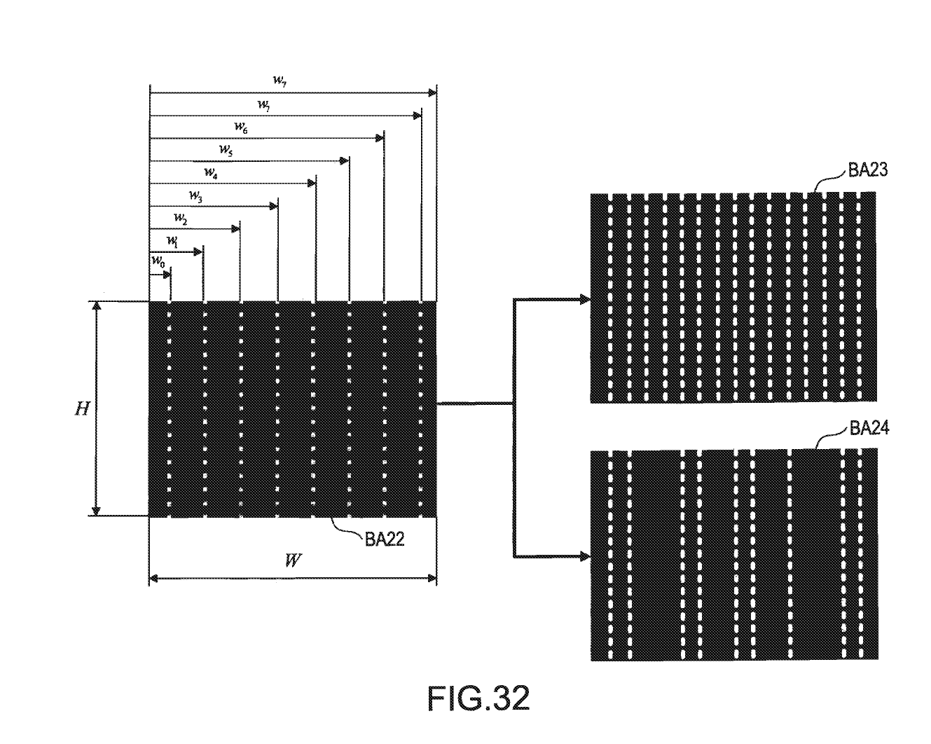

Meanwhile, when the end-of-processing judging unit B49 judges that the evaluation value Error is not sufficiently small or the difference from the previous time is large, as shown in FIG. 32, the end-of-processing judging unit B49 reconstructs image data in which a pitch of a vertical line of an initial vertical display image BA22 is set to 0.5 times, like an image BA23, or image data in which a pitch of a vertical line is set to have an unequal interval, like an image BA24. The reconstructed image data is input to the projector B100 and a display image is displayed on the basis of the reconstructed image data. The horizontal line image data is reconstructed in the same manner.

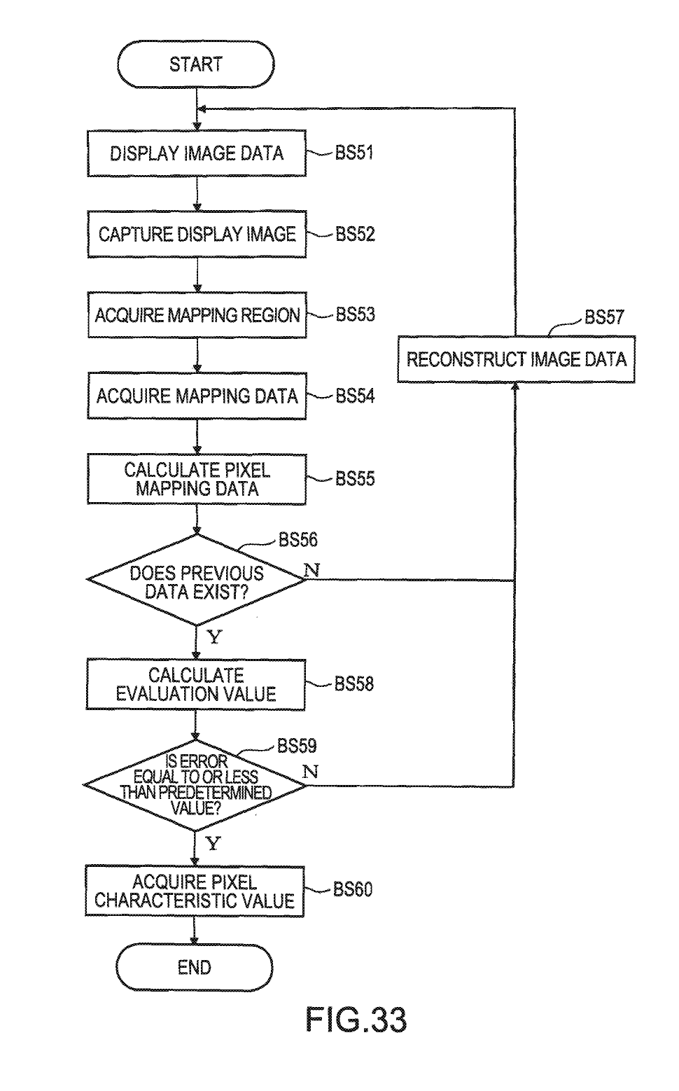

Next, the operation of the pixel characteristic value acquiring system B4 according to the fourth embodiment well be described with reference to a flowchart shown in FIG. 33.

(1) First, the display image forming unit B32 inputs the vertical line image data, the horizontal line image data, and the characteristic value acquisition image data to the projector B100, and causes the individual display images to be displayed on the screen B105 (Step BS51). Then, the display image introducing unit B31 captures and introduces the individual display images (Step BS52).

(2) Next, the mapping region acquiring unit B33 acquires the mapping region (Step BS53), and the approximate function setting unit B34 acquires mapping data on the basis of the acquired mapping region (Step BS54).

(3) Next, the pixel mapping calculation unit B50 calculates the pixel mapping data through the above-described processing (Step BS55). These steps are the same as those in the third embodiment.

(4) The end-of-processing judging unit B49 judges whether or not the pixel mapping data calculated at the previous time exists (Step BS56). When the pixel mapping data calculated at the previous time does not exist, the reconstruction of the image data, such as the image BA23 or the image BA24, is performed (Step BS57), and the reconstructed image data is input to the projector B100. Then, Steps BS51 to BS55 are repeated.

(5) The end-of-processing judging unit B49 calculates the evaluation value Error based on the expression (46) on the basis of pixel mapping data based on the reconstructed image data obtained by repeating Steps BS51 to BS55 and the previous pixel mapping data (Step BS58), and judges whether or not the evaluation value Error is equal to or less than a predetermined threshold value (Step BS59).

(6) When it is judged that the evaluation value Error is not equal to or less than the predetermined threshold value, the end-of-processing judging unit B49 reconstructs the image data, such as the image BA23 or the image BA24, and inputs the reconstructed image data to the projector B100. Then, Steps BS51 to BS55 are repeated, and new pixel mapping data is calculated. Meanwhile, when it is judged that the evaluation value Error is equal to or less than the predetermined threshold value, the processing ends. Then, the pixel characteristic value acquiring unit B36 starts to acquire the pixel characteristic value based on the latest pixel mapping data (Step BS60).

### MODIFICATIONS

The invention is not limited to the above-described embodiments, but various modifications and changes can be made within the scope capable of achieving the advantages of the invention.

In the embodiments, in order to acquire the pixel characteristic value of the display image by the projector 100 or B100, the pixel position acquiring method according to the invention is used, but the invention is not limited thereto. The pixel position acquiring method according to the invention may be used in order to acquire a pixel characteristic value of a direct-view-type liquid crystal display, a plasma display, or an organic EL display with high accuracy.

Besides, as for the specific structure and shape upon the execution of the invention, other structures may be used within the scope capable of achieving the advantages of the invention.

What is claimed is:

1. A pixel position acquiring method that captures a display image displayed on a screen by an image-capturing device, and acquires, on the basis of image-capturing data, correspondence between a pixel position of an image generating device to be projected on the screen and a position where the pixel position is mapped on the image-capturing data, the pixel position acquiring method comprising:
causing a first line image having a plurality of straight lines extending along a vertical direction of the image generating device to be displayed on the screen;
capturing a display image based on the first line image by the image-capturing device and acquiring first image-capturing data;
causing a second line image having a plurality of straight lines extending along a horizontal direction of the image generating device to be displayed on the screen;
capturing a display image based on the second line image by the image-capturing device and acquiring second image-capturing data;
cutting a plurality of image-capturing lines mapped on the first image-capturing data per a region including each image-capturing line;
setting an approximate function expressing each image-capturing line in the first image-capturing data on the basis of the region of each cut image-capturing line;
cutting a plurality of image-capturing lines mapped on the second image-capturing data per a region including each image-capturing line;
setting an approximate function expressing each image-capturing line in the second image-capturing data on the basis of the region of each cut image-capturing line; and
finding, on the basis of the approximate functions set by the first image-capturing data and the second image-capturing data, an association between the pixel position of the image generating device and the position where the pixel position is mapped on the image-capturing data.

2. The pixel position acquiring method according to
wherein the first line image and the second line image each includes at least four markers providing the correspondence with the individual image-capturing data, and
the cutting of the plurality of image-capturing lines mapped on the first or second image-capturing data as the region including each image-capturing line includes:
setting, on the basis of a marker correspondence of the first line image and the first image-capturing data, a transform expression of the first line image and the first image-capturing data;
setting, on the basis of a marker correspondence of the second line image and the second image-capturing data, a transform expression of the second line image and the second image-capturing data;
setting a region surrounding each straight line of the first or second line image;
transforming the region surrounding each straight line of the first or second line image by the set transform expression; and
cutting, on the basis of the transformed region, each image-capturing line of the first image-capturing data or the second image-capturing data.

3. The pixel position acquiring method according to claim 1
wherein, in the setting of the approximate function expressing each image-capturing line, when an xy coordinate system with a vertical direction of the first image-capturing data or the second image-capturing data as a y axis and a horizontal direction thereof as an x axis is set, each image-capturing line mapped on the first image-capturing data is set as an approximate function expressed by a polynomial expression of x in a variable y, and each image-capturing line mapped on the second image-capturing data is set as an approximate function expressed by a polynomial expression of y in a variable x.

4. The pixel position acquiring method according to claim 1,
wherein the finding of the association between the pixel position of the image generating device and the position where the pixel position is mapped on the image-capturing data includes:
associating each straight line on the first line image with each image-capturing line on the first image-capturing data, and associating each straight line on the second line image with each image-capturing line on the second image-capturing data;
finding, on the basis of the approximate function set according to each associated image-capturing line, intersections of the plurality of image-capturing lines on the first image-capturing data and the plurality of image-capturing lines on the second image-capturing data; and
setting, on the basis of the found intersections, an interpolation function for providing an arbitrary point within a region surrounded by two adjacent image-capturing lines on the first image-capturing data and two adjacent image-capturing lines on the second image-capturing data.

5. The pixel position acquiring method according to claim 1, further comprising, after the finding of the association between the pixel position of the image generating device and the position where the pixel position is mapped on the image-capturing data:
performing a quality evaluation on the basis of the previously calculated correspondence between the pixel position of the image generating device and the position where the pixel position is mapped on the image-capturing data, and the recalculated correspondence between the pixel position of the image generating device and the position where the pixel position is mapped on the image-capturing data,
wherein, when the evaluation result is bad, the causing of the first line image to be displayed on the screen of the finding of the association between the pixel position of the image generating device and the position where the pixel position is mapped on the image-capturing data are repeated again.

6. The pixel position acquiring method according to claim 5,
wherein, upon the repetition, at least one of the causing of the first line image to be displayed and the causing of the second line image to be displayed causes an updated line image with an interval between the straight lines narrower than the previous time to be displayed.

7. The pixel position acquiring method according to claim 5,
wherein, upon the repetition, at least one of the causing of the first line image to be displayed and the causing of the second line image to be displayed causes a line image in which straight lines are arranged at different positions from the previous time to be displayed.

8. An image processing apparatus that captures a display image displayed on a screen by an image-capturing device, and acquires, on the basis of image-capturing data, a correspondence between a pixel position of an image generating device to be projected on the screen and a position where the pixel position is mapped on the image-capturing data, the image processing apparatus comprising:
a unit that causes a first line image having a plurality of straight lines extending along a vertical direction of the image generating device to be displayed on the screen;
a unit that captures a display image based on the first line image by the image-capturing device and acquires first image-capturing data;
a unit that causes a second line image having a plurality of straight lines extending along a horizontal direction of the image generating device to be displayed on the screen;
a unit that captures a display image based on the second line image by the image-capturing device and acquires second image-capturing data;
a unit that cuts a plurality of image-capturing lines mapped on the first image-capturing data per a region including each image-capturing line;
a unit that sets an approximate function expressing each image-capturing line in the first image-capturing data on the basis of the region of each cut image-capturing line;
a unit that cuts a plurality of image-capturing lines mapped on the second image-capturing data per a region including each image-capturing line;
a unit that sets an approximate function expressing each image-capturing line in the second image-capturing data on the basis of the region of each cut image-capturing line; and
a unit that finds, on the basis of the approximate functions set by the first image-capturing data and the second image-capturing data, an association between the pixel position of the image generating device and the position where the pixel position is mapped on the image-capturing data.

9. A pixel position acquiring method that captures a display image displayed on a screen by an image-capturing device, and acquires, on the basis of image-capturing data, a correspondence between a pixel position of an image generating device to be displayed on the screen and a position where the pixel position is mapped on the image-capturing data, the pixel position acquiring method comprising:
causing an image having a gradation line subjected to a gradation along an extension direction to be displayed on the screen;
capturing the display image displayed on the screen by the image-capturing device and acquiring the image-capturing data; and
associating, on the basis of the gradation line displayed on the screen and a gradation image-capturing line mapped on the image-capturing data, the pixel position of the image generating device with the position where the pixel position is mapped on the image-capturing data.

10. The pixel position acquiring method according to claim 9,
wherein the causing the image having the gradation line to be displayed on the screen includes:
causing a first line image having a plurality of gradation lines extending along a vertical direction of the image generating device to be displayed on the screen; and
causing a second line image having a plurality of gradation lines extending along a horizontal direction of the image generating device to be displayed on the screen,
the acquiring of the image-capturing data includes:
capturing a display image based on the first line image by the image-capturing device and acquiring first image-capturing data; and
capturing a display image based on the second line image by the image-capturing device and acquiring second image-capturing data, and
the associating of the pixel position of the image generating device and the position where the pixel position is mapped on the image-capturing data includes:
cutting a plurality of gradation image-capturing lines mapped on the first image-capturing data per a region including each gradation image-capturing line;
setting an approximate function expressing each gradation image-capturing line in the first image-capturing data on the basis of the region of each cut gradation image-capturing line;
cutting a plurality of gradation image-capturing lines mapped on the second image-capturing data per a region including each gradation image-capturing line;
setting an approximate function expressing each gradation image-capturing line in the second image-capturing data on the basis of the region of each cut gradation image-capturing line; and
finding, on the basis of the approximate functions set by the first image-capturing data and the second image-capturing data, the association between the pixel position of the image generating device and the position where the pixel position is mapped on the image-capturing data.

11. The pixel position acquiring method according to claim 10,
wherein the first line image and the second line image each includes at least four markers providing the correspondence with the individual image-capturing data, and
the cutting of the plurality of gradation image-capturing lines mapped on the first or second image-capturing data as the region including each gradation image-capturing line includes:
setting, on the basis of a marker correspondence of the first line image and the first image-capturing data, a transform expression of the first line image and the first image-capturing data;
setting, on the basis of a marker correspondence of the second line image and the second image-capturing data, a transform expression of the second line image and the second image-capturing data;
setting a region surrounding each gradation line of the first or second line image;
transforming the region surrounding each gradation line of the first or second line image by the set transform expression; and
cutting, on the basis of the transformed region, each gradation image-capturing line of the first image-capturing data or the second image-capturing data.

12. The pixel position acquiring method according to claim 10,
wherein, in the setting of the approximate function expressing each gradation image-capturing line, when an xy coordinate system with a vertical direction of the first image-capturing data or the second image-capturing data as a y axis and a horizontal direction thereof as an x axis is set, each gradation image-capturing line mapped on the first image-capturing data is set as an approximate function expressed by a polynomial expression of x in a variable y, and each gradation image-capturing line mapped on the second image-capturing data is set as an approximate function expressed by a polynomial expression of y in a variable x.

13. The pixel position acquiring method according to claim 12,
wherein each gradation image-capturing line mapped on the first image-capturing data is set as an approximate function expressed by a polynomial expression of x in a variable y using a weight coefficient according to the gradation image-capturing line, and
each gradation image-capturing line mapped on the second image-capturing data is set as an approximate function expressed by a polynomial expression of y in a variable x using a weight coefficient according to the gradation image-capturing line.

14. The pixel position acquiring method according to claim 10,
wherein the finding of the association between the pixel position of the image generating device and the position where the pixel position is mapped on the image-capturing data includes:
associating each gradation line on the first line image with each gradation image-capturing line on the first image-capturing data, and associating each gradation line on the second line image with each gradation image-capturing line on the second image-capturing data;
finding, on the basis of the approximate function set according to each associated gradation image-capturing line, intersections of the plurality of gradation image-capturing lines on the first image-capturing data and the plurality of gradation image-capturing lines on the second image-capturing data; and
setting, on the basis of the found intersections, an interpolation function for providing an arbitrary point within a region surrounded by two adjacent gradation image-capturing lines on the first image-capturing data and two adjacent gradation image-capturing lines on the second image-capturing data.

15. The pixel position acquiring method according to claim 10, further comprising, after the finding of the association between the pixel position of the image generating device and the position where the pixel position is mapped on the image-capturing data:
performing a quality evaluation on the basis of the previously calculated correspondence between the pixel position of the image generating device and the position where the pixel position is mapped on the image-capturing data, and the recalculated correspondence between the pixel position of the image generating device and the position where the pixel position is mapped on the image-capturing data,
wherein, when the evaluation result is bad, the causing of the first line image to be displayed on the screen to the finding of the association between the pixel position of the image generating device and the position where the pixel position is mapped on the image-capturing data are repeated again.

16. The pixel position acquiring method according to claim 15,
wherein, upon the repetition, at least one of the causing of the first line image to be displayed and the causing or the second line image to be displayed causes an updated line image with an interval between the gradation lines narrower than the previous time to be displayed.

17. The pixel, position acquiring method according to claim 15,
wherein, upon the repetition, at least one of the causing of the first line image to be displayed and the causing of the second line image to be displayed causes a line image in which gradation lines are arranged at different positions from the previous time to be displayed.
